(19) United States
(12) Patent Application Publication
(10) Pub. No.: US 2026/0233853 A1
(43) Pub. Date: Aug. 13, 2026

(54) ASSESSMENT OF IMPACT LOCALIZATION AND ENERGY

(71) Applicant: UNIVERSITY OF SOUTH CAROLINA, COLUMBIA, SC (US)

(72) Inventors: LI AI, LEXINGTON, SC (US); PAUL ZIEHL, IRMO, SC (US)

(21) Appl. No.: 19/414,632

(22) Filed: Dec. 10, 2025

Related U.S. Application Data
(60) Provisional application No. 63/756,327, filed on Feb. 10, 2025.

(51) Int. Cl. B64D 45/00; B64F 5/60

(52) U.S. Cl. CPC B64D 45/00; B64F 5/60; B64D 2045/0085

(57) ABSTRACT

In-flight monitoring systems for the advanced air mobility (AAM) market use acoustic emission sensing systems and methods for assessment of impact localization and energy, including particularly in-flight localization and characterization (energy level) of low-velocity impact events. AE sensors serve two roles: detection of impact events and assess damage associated with those events. To achieve minimally intrusive sensing, machine learning algorithms based on acoustic emission signal are used to reduce the number of sensors and computational complexity. Acoustic emission data for in-flight impact is gathered continuously at high sampling rates (for example, in the range of 500,000 to 1 million samples per second). AE sensing can address low-velocity impact, hard landings, and fatigue. Some cases use light weight fiber optic sensing systems (strain, temperature) which are multiplexed and capture temperature, displacement, vibration, and static/dynamic strain, at scan rates in the range of 5,000 samples per second.

### PRIORITY CLAIM

The present application claims the benefit of priority of U.S. Provisional Patent Application No. 63/756,327, titled Assessment of Impact Localization and Energy, filed Feb. 10, 2025, and which is fully incorporated herein by reference for all purposes.

### STATEMENT REGARDING FEDERALLY SPONSORED RESEARCH OR DEVELOPMENT

This invention was made with government support under Grant No. 80NSSC21M0113, awarded by the National Aeronautics and Space Administration (NASA). The government has certain rights in the invention.

### BACKGROUND OF THE PRESENTLY DISCLOSED SUBJECT MATTER

Structural health monitoring (SHM)/nondestructive evaluation (NDE) exists as a tool in conjunction with complex structural systems, some of which are related to the transportation infrastructure.

The disclosure deals with system and method for sensors and algorithms for in-flight health monitoring and assessment. In particular, presently disclosed subject matter relates to in-flight monitoring systems for the advanced air mobility (AAM) market.

The AAM market is characterized by a need for rapid manufacturing of structural components; ruggedness of these components with respect to impact, fatigue and other loading scenarios; and a desire to minimize scheduled maintenance. A desirable structural monitoring system for this market would be light in weight, effective in terms of cost, and require minimal power consumption. The structural monitoring system would ideally be capable of localizing and characterizing damage during flight.

The current state of monitoring involves the practice of visually assessing damage of a certain size (for example, barely visible impact damage) and then repairing or considering through follow-on inspections.

The presently disclosed approach benefits from re-thinking of the current inspection and maintenance/repair approach and assesses the need for repair (if any) based on data received and then evaluated primarily from in-flight sensing. In such way, the tradeoff between the cost of the sensing system and the cost of scheduled inspection and maintenance/repair becomes of interest.

### SUMMARY OF THE PRESENTLY DISCLOSED SUBJECT MATTER

The presently disclosed systems and corresponding and/or associated method subject matter relates to in-flight monitoring systems for the advanced air mobility (AAM) market. More particularly, per presently disclosed subject matter, assessments made be made regarding the need for repair (if any) based on data received and then evaluated primarily from in-flight sensing.

In one exemplary embodiment disclosed herewith, a system and method for in-flight sensing and assessment is described.

It is to be understood that the presently disclosed subject matter equally relates to associated and/or corresponding methodologies. One exemplary such method relates to a computer-implemented method for assessing impact localization in an Advanced Air Mobility (AAM) vehicle structure during flight operations, the method comprising coupling at least one sensor directly to an associated AAM vehicle structure to be monitored; continuously acquiring a raw Acoustic Emission (AE) waveform datastream from the at least one sensor; processing the raw AE waveform datastream to isolate a primary incident elastic wave packet corresponding to a structural impact event by applying a minimum amplitude threshold to filter background noise; and implementing a temporal signal constraint logic defined by a Peak Definition Time (PDT) and a Hit Lockout Time (HLT) to retain only the earliest-arriving signal having the greatest amplitude, to isolate the primary incident elastic wave packet from subsequent reflected waves; generating from the isolated primary incident elastic wave packet a multi-dimensional feature vector comprising at least one distinct Acoustic Emission (AE) feature including at least one of amplitude, energy, rise time, duration, counts, and signal strength; inputting the multi-dimensional feature vector into a Random Forest Classifier model trained to predict from the multi-dimensional feature vector input a classification output corresponding to a defined spatial region of impact localization on the AAM structure; and generating an alert signal indicating the predicted spatial region of impact localization for the AAM structure.

Other example aspects of the present disclosure are directed to systems, apparatus, tangible, non-transitory computer-readable media, user interfaces, memory devices, and electronic devices for in-flight sensing and assessment. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a system for assessing impact localization in an Advanced Air Mobility (AAM) vehicle structure during flight operations, the system comprising at least one sensor directly coupled to an associated AAM vehicle structure to be monitored, and continuously outputting a raw Acoustic Emission (AE) waveform datastream; a Random Forest Classifier model training to predict from a multi-dimensional feature vector input a classification output corresponding to a defined spatial region of impact localization on the AAM structure; one or more processors; and one or more non-transitory computer-readable media that store instructions that, when executed by the one or more processors, cause the one or more processors to perform operations. Such operations preferably comprise processing the raw AE waveform datastream to isolate a primary incident elastic wave packet corresponding to a structural impact event by applying a minimum amplitude threshold to filter background noise; and implementing a temporal signal constraint logic defined by a Peak Definition Time (PDT) and a Hit Lockout Time (HLT) to retain only the earliest-arriving signal having the greatest amplitude, to isolate the primary incident elastic wave packet from subsequent reflected waves; generating from the isolated primary incident elastic wave packet a multi-dimensional feature vector comprising at least one distinct Acoustic Emission (AE) feature including at least one of amplitude, energy, rise time, duration, counts, and signal strength; and inputting the multi-dimensional feature vector into the Random Forest Classifier model as training data or data to process.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 shows an image of an example of an LM-PEAK preform;

FIG. 2(a) shows an image of an exemplary drop tower;

FIG. 2(b) illustrates an image (enlarged) of an exemplary impactor and an associated photogate mounted on the drop tower of FIG. 2(a);

FIG. 3 illustrates an image of an exemplary fixture and setup (that is, an exemplary experimental setup for a compression test);

FIG. 4(a) illustrates a plurality of images of test pieces as impacted and showing visually observable damage, and illustrates a corresponding plurality of respective ultrasonic c-scans;

FIG. 4(b) graphically illustrates in table format (Table 1) codes for failure modes in CAI specimens as reproduced from ASTM 7137;

FIG. 4(c) graphically illustrates in table format (Table 2) data that complied with the ASTM 7137 definition of acceptable failures;

FIG. 5 depicts four representative failure modes;

FIG. 6 graphically illustrates results of compression after impact strength vs impact energy for specimens with acceptable failure mode;

FIG. 7 graphically illustrates results of compression after impact strength vs impact energy for all specimens;

FIG. 8 graphically illustrates results of compressive strength and dent depth for CAI tests with differing impact energies;

FIG. 9 graphically illustrates results of comparison of simulated and experimentally determined compression after impact strength;

FIGS. 10(a) and 10(b) present respective images of an exemplary demonstrator specimen;

FIG. 11 schematically and through images represents an exemplary experimental setup related to training of impact data;

FIG. 12 schematically and through images represents an exemplary sensor layout of an experimental setup;

FIG. 13(a) graphically and schematically illustrates an exemplary acoustic emission sensing arrangement;

FIG. 13(b) graphically illustrates a representative waveform recorded during an impact experiment;

FIG. 13(c) graphically illustrates in table format (Table 3) fifteen features selected in accordance with presently disclosed technology as having shown positive performance for source localization;

FIG. 13(d) graphically illustrates in table format (Table 4) details of exemplary sensors per presently disclosed technology for potential use in monitoring during Advanced Air Mobility (AAM) flights;

FIG. 13(e) graphically illustrates in table format (Table 5) detailed breakdown of the scores for each criterion applied to the sensors of FIG. 13(d) and the total scores for all potential systems;

FIG. 13(f) graphically illustrates multiple waveforms overlapping or close together, produced for example during acoustic emissions (AE) data acquisition, and further illustrating various timing parameters introduced in accordance with the presently disclosed subject matter;

FIG. 14 shows imagery illustrating exemplary AEwin feature extraction settings;

FIG. 15 graphically illustrates the structure of an exemplary random forest regression model with 100 decision trees, in accordance with presently disclosed subject matter;

FIG. 16(a) schematically illustrates exemplary high-definition fiber optic sensing subject matter for use in accordance with the presently disclosed subject matter;

FIG. 16(b) graphically and with images illustrates an exemplary confusion matrix of exemplary localization results when only sensor is utilized, in accordance with presently disclosed subject matter;

FIG. 17(a) graphically illustrates strain captured by a fiber optic sensor prior to, during, and after an impact event;

FIG. 17(b) graphically illustrates data fusion using nonlinear regression model, in accordance with presently disclosed subject matter;

FIG. 18(a) graphically illustrates the impact or tradeoff of increasing the number of sensors on localization accuracy, cost, and weight, in accordance with presently disclosed subject matter;

FIG. 18 b) graphically depicts exemplary errors in localization when using two to five sensors.

FIG. 19 graphically and with imagery illustrates exemplary impact testing on the demonstrator using a drop tower, in accordance with presently disclosed subject matter;

FIG. 20 graphically and with imagery illustrates localization models based on exemplary signals generated with the exemplary presently disclosed drop tower set-up;

FIG. 21 graphically illustrates estimation of impact energy, comparing severity vs. Historic index;

FIG. 22 graphically illustrates the use of multiple fiber optic sensors on the exemplary presently disclosed demonstrator;

FIG. 23 graphically illustrates in table format (Table 6) summary of AE data (in terms of severity) and maximum strain recorded by an exemplary fiber optic sensor for the different exemplary impact energy levels considered in accordance with presently disclosed subject matter;

FIG. 24 schematically represents suggested initial sensor types and locations for notional vehicles, in accordance with presently disclosed subject matter;

FIG. 25 schematically illustrates multiple images relating to impact localization and energy estimation for one panel (panel 6) on one side of a representative Quadrotor;

FIGS. 26-29 schematically represent multiple images which respectively represent visualization of localization and energy estimation for remaining panels of a representative quadrotor, including panels 1, 5, 3, and 4 thereof, respectively.

FIG. 30 schematically represents two sensing options in accordance with presently disclosed subject matter, through illustration of multiple images, in the context of landing apparatus for a representative quadrotor; and

FIG. 31 graphically illustrates in table format (Table 7) representative cost and weight of the two options of present FIG. 30, presented for a representative quadrotor.

Repeat use of reference characters in the present specification and drawings is intended to represent the same or analogous features, elements, or steps of the presently disclosed subject matter.

### Detailed Description of the Presently Disclosed Subject Matter

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to subject matter for in-flight sensing and assessment.

The presently disclosed sensing technology addresses or considers: compression data after impact testing, monitoring, and modeling; impact localization algorithms; tradeoffs between number of sensors and accuracy of localization; and impact energy estimation algorithms

Sensors and Algorithms for in-Flight Health Monitoring and Assessment
a) Compression Data after Impact Testing, Monitoring, and Modeling

Compression after impact (CAI) data was obtained in general conformance with American Society for Testing and Materials (“ASTM”) D7137, Standard Test Method for Compressive Residual Strength Properties of Damaged Polymer Matrix Composite Plates. Such data acquisition was conducted to better understand the mechanical behavior of the thermoplastic material after impact, which has been little considered in comparison to thermosets, and to gain insight into capabilities of both fiber optic and acoustic emission sensing approaches.

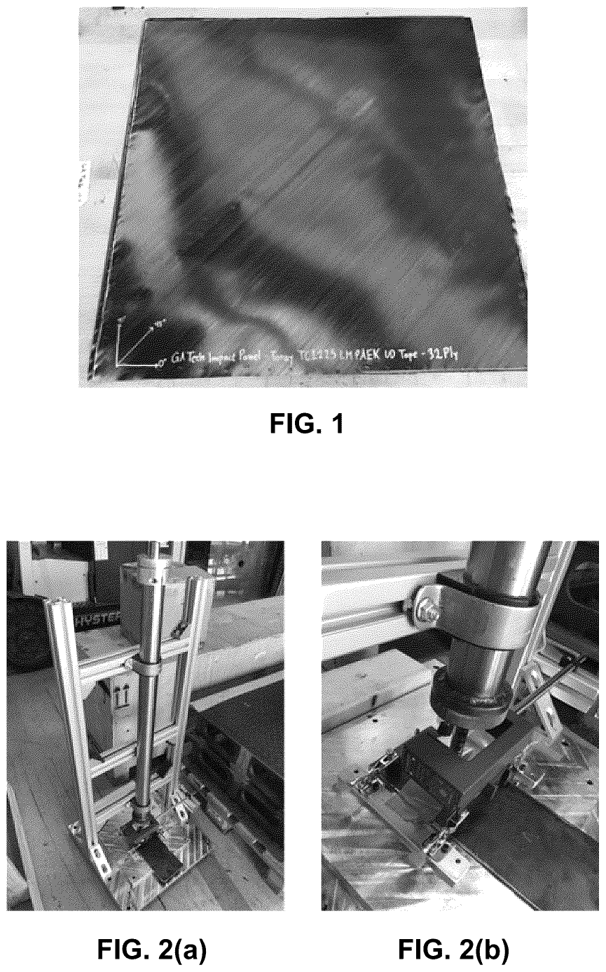

For example, fourteen panels were fabricated and subjected to various levels of impact energy, ranging from 15 to 60 J (531 to 2,124 in-lb/in for the thickness of interest). The material for the panels was cut and tacked through soldering to create the preforms. In particular, FIG. 1 shows an image of an example of an LM-PEAK preform. The samples for data acquisition were fabricated with Toray T1225 LM-PAEK UD Tape having a stacking sequence of [45,0,−45,90] 4S (32 ply). Samples were made by creating a 0.6096 m (24.0 in.) by 0.6096 m (24.0 in.) panel which was cured using a Wabash Press and then cut into 0.1016 m (4.00 in.) by 0.1524 m (6.00 in.) samples with a wet saw.

Impact testing was performed with an adjustable height drop tower. FIG. 2(a) shows an image of the exemplary drop tower. FIG. 2(b) illustrates an image (enlarged) of an exemplary impactor and an associated photogate mounted on the drop tower of FIG. 2(a).

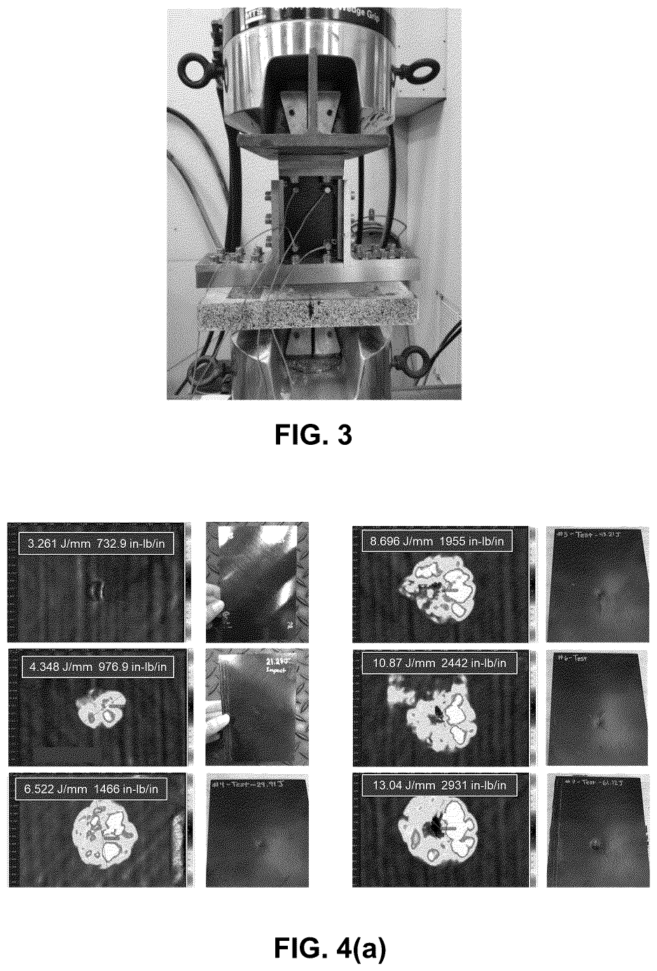

After samples were impacted, each panel was tested in compression. FIG. 3 illustrates an image of the exemplary fixture and setup (that is, the exemplary experimental setup for the compression test). The side surfaces as well as end surface of the material were clamped and the top assembly was used to apply compressive loading.

### Results of Impact Testing

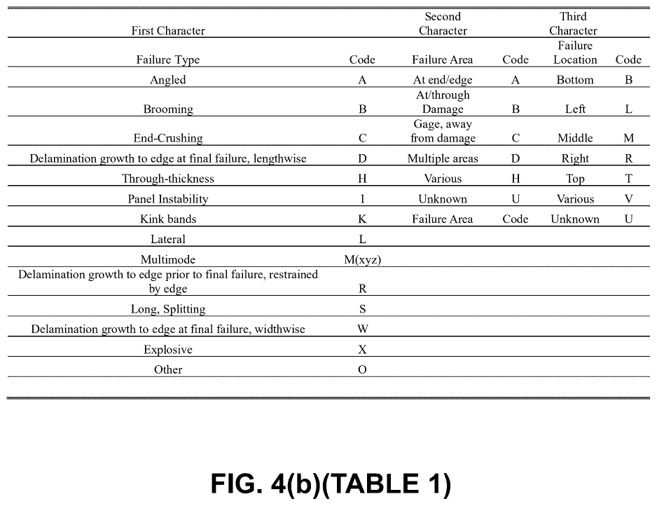

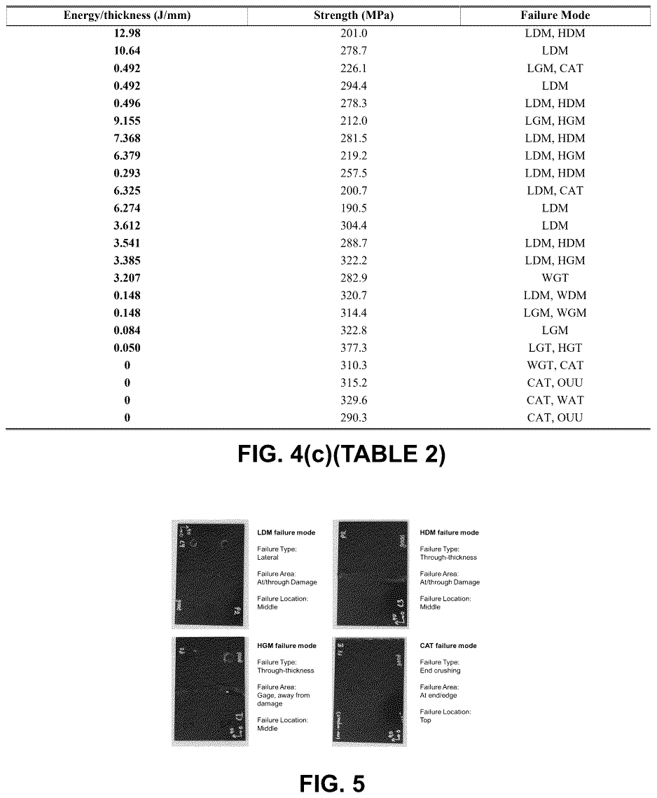

FIG. 4(a) illustrates a plurality of images of test pieces as impacted and showing visually observable damage, and illustrates a corresponding plurality of respective ultrasonic c-scans. In particular, FIG. 4(a) shows the results of impact testing conducted on the 0.1016 m (4.00 in.) by 0.1524 m (6.00 in.) panels. Such panels were then inspected in an immersion tank through ultrasonic c-scanning. The suitability of the concept of barely visible impact damage is a subject of current debate for thermoplastic composites, in part due to differences in damage mechanisms observed between thermoset and thermoplastic composites. Given the current state of the practice, however, it is likely that assessment through barely visible impact damage (BVID) will be initially transferred to thermoplastics. In these specimens, it may be observed that BVID occurred at approximately 4.348 J/mm.

FIG. 4(b) (Table 1) in table format presents codes for failure modes in CAI specimens as reproduced from ASTM 7137. ASTM 7137 states all of the failure modes in the ‘first character’ column of FIG. 4(b) (Table 1) are acceptable, with the exception of end-crushing; edge restrained delamination growth (for which delamination(s) grow prior to final failure and additional force-carrying capability results from edge restraint); or panel instability (unless the specimen is dimensionally representative of a particular structural application).

FIG. 4(c) (Table 2) provides the data that complied with the ASTM 7137 definition of acceptable failures. FIG. 4(c) (Table 2) provides an overview of how the samples performed under different impact energies (i.e., compression after impact results). The sample label, impact energy, strength, energy/thickness, and the observed modes of failure are provided.

FIG. 5 depicts four representative failure modes. The LDM mode is characterized by lateral failure occurring at or through damage in the middle of the specimen. The HGM mode involves through-thickness failure in the gauge area, away from the damage, also located in the middle. The HDM mode is similar to HGM but occurs at or through damage in the middle. Finally, the CAT mode is identified by end crushing failure at the end or edge of the specimen, located near the top.

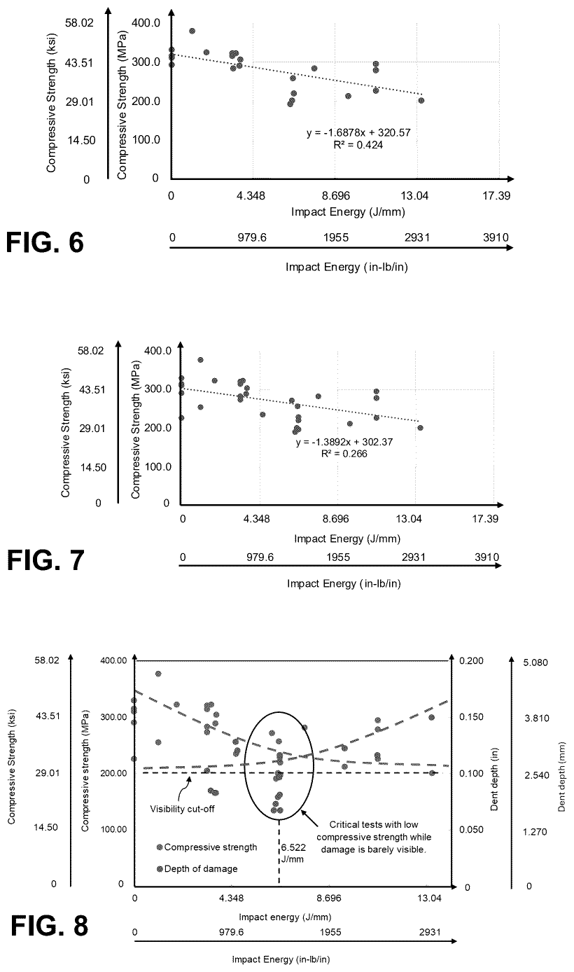

FIG. 6 graphically illustrates results of compression after impact strength vs impact energy for specimens with acceptable failure mode. FIG. 7 graphically illustrates results of compression after impact strength vs impact energy for all specimens. The data shows that the overall strength of the panels decreases approximately 17 MPa (2 ksi) for each 10 J (354 in-lb/in) of impact energy.

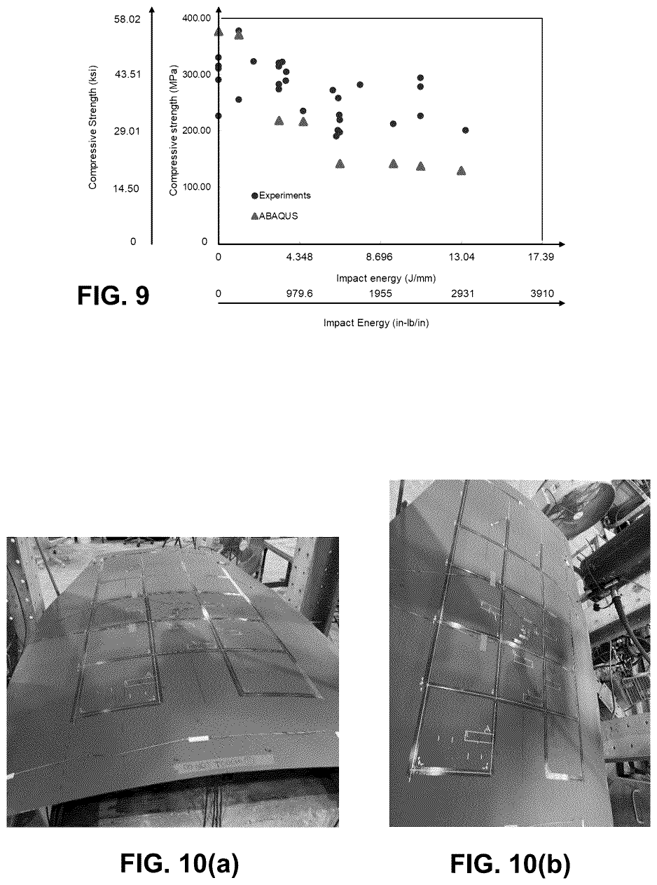

Damage caused by low velocity impacts in composite materials may go undetected resulting in significant damage being unnoticeable. In the testing described above, compressive strength decreased substantially for differing levels of impact energy. This decrease occurs with dent depth below 0.10 in. (2.54 mm) and impact energy below 6.522 J/mm, even though the resulting damage is barely visible (refer to FIG. 8). In other words, FIG. 8 graphically illustrates results of compressive strength and dent depth for CAI tests with differing impact energies. Simulations were carried out using the commercial finite element (FE) software, ABAQUS (refer to FIG. 9), to better understand the development and growth of damage in the composite material during the compression after impact (CAI) testing and to better understand impact magnitudes that may be of interest for development of the sensing systems. In other words, FIG. 9 graphically illustrates results of comparison of simulated and experimentally determined compression after impact strength. ABAQUS/Explicit analysis tracked the compressive strength after impact relatively accurately when compared to the experimental results.

### b) Developing Impact Localization Algorithms

In the context of advanced air mobility various sources pose risks to vehicles, including natural events such as bird strikes and hailstorms and human-caused hazards including debris. Certain types of runway/vertiport debris may consistently impact specific portions of a vehicle, assuming some consistency in debris type, size, and speed during takeoff or landing. In areas with high bird populations, the average mass and flight speed of local bird species could lead to a degree of consistency in impact energy. The inherent randomness and unpredictability of these events result in large variations in impact energies. To simplify the scenario, considerations initially focused on impacts with consistent testing techniques and this was later expanded to more realistic scenarios.

### Impact Experiment Setup

To assess the efficacy of impact localization methodologies and to train algorithms, an impact experiment was conducted on the demonstrator specimen (FIGS. 10(a) and 10(b)). In other words, FIGS. 10(a) and 10(b) present respective images of an exemplary demonstrator specimen.

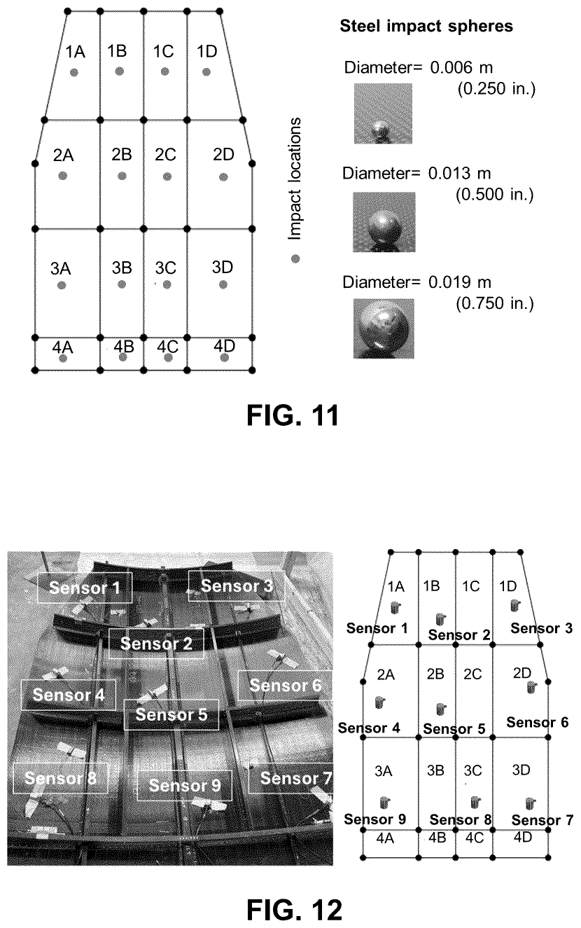

FIG. 11 schematically and through images represents the exemplary experimental setup related to training of impact data. A training approach involving steel sphere impacts on the demonstrator was employed to train and also to assess the presently disclosed impact localization approach. Spheres were consistently positioned at 0.610 m (24.0 in.) from the surface. As shown in FIG. 11, the smallest sphere had a diameter of 0.006 m (0.250 in.), the medium sphere had diameter of 0.013 m (0.500 in.), and the largest had a diameter of 0.019 m (0.750 in.).

The impact energies for the small, medium, and large spheres were 0.006, 0.050, and 0.170 Joules, respectively. A guide tube was utilized to regulate the location and height of each impact. As schematically represented in FIG. 11, the demonstrator featured sixteen sections with one distinct impact point in each section. Acoustic emission sensors were affixed to the bottom (representing the interior) of the demonstrator, with a total of nine sensors employed. FIG. 12 schematically and through images represents the exemplary sensor layout of the experimental setup. Each impact location was subjected to 60 impacts per sphere size on each of the twelve impact points, resulting in a total of 2,160 impacts on the demonstrator. AE signals were recorded by an off-the-shelf acoustic emission data acquisition system.

The AE system (MISTRAS Group Inc., Princeton Junction, NJ) utilized PKWDI sensors. This sensor was selected for noise reduction and low power consumption. The amplitude threshold was configured at 32 dB with a sampling rate of 1 MHz. A pre-trigger time of 256 μs was established to capture signal initiation. The peak definition time (PDT), representing the duration from threshold crossing to peak amplitude, was set at 200 μs. A signal duration of 2,000 μs was employed to identify the peak, while the hit definition time (HDT)—governing the termination of impact recording—was configured at 400 μs. Signal recording commenced when the voltage exceeded the threshold value and ceased when the HDT parameter duration elapsed without additional threshold crossings. Lastly, the hit lockout time (HLT) was established at 400 us to minimize reflected hits and late-arriving signals.

The presently disclosed impact localization module is designed to determine the location of impacts on Advanced Air Mobility (AAM) vehicles through analyzing Acoustic Emission (AE). This module leverages acoustic emission (AE) sensing and machine learning, specifically a Random Forest Classifier.

Acoustic Emission: ASTM 1316 defines AE as “a class of phenomena in which transient elastic waves are generated by, or result from, the rapid release of energy from a local source or multiple sources in a material” [1]. The nature of the acoustic emission phenomenon is that microscopic damage events triggered by stress concentrations in the material release energy in the form of elastic waves, which include a mixture of longitudinal waves (compression waves) and transverse waves (shear waves) [2].

In general terms, when a material is subjected to external forces or internal stress, its internal structure gradually accumulates energy. In composite materials, for example, this process can result in fiber breakage and matrix crack initiation. When the local energy accumulation exceeds the material strength, instantaneous damage occurs, such as crack formation or propagation. The released energy is transformed into stress waves [3]. These waves propagate at a certain velocities in the material, with different modes propagating at different velocities, and are affected by the material elastic modulus, density and geometry. By attaching an AE sensor, typically piezoelectric based, to the surface of an object, AE waves can be detected and recorded. The technique of diagnosing the condition of an object by collecting and analyzing AE wave signals is known as AE monitoring and/or evaluation [4].

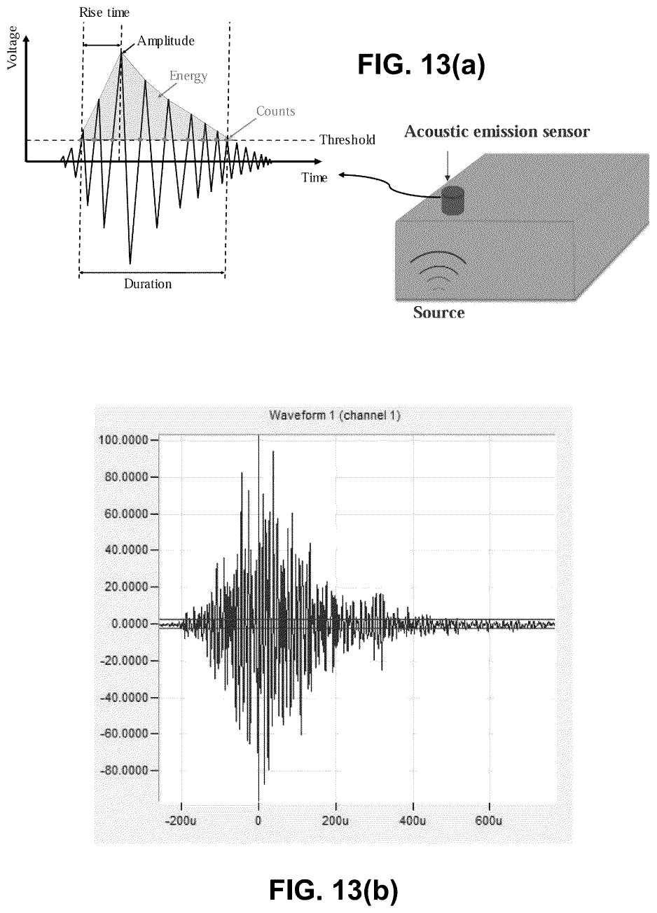

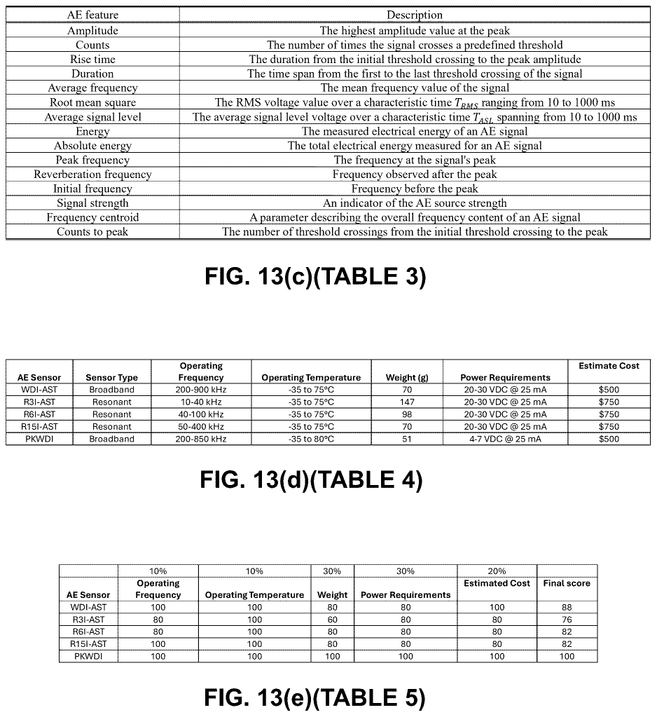

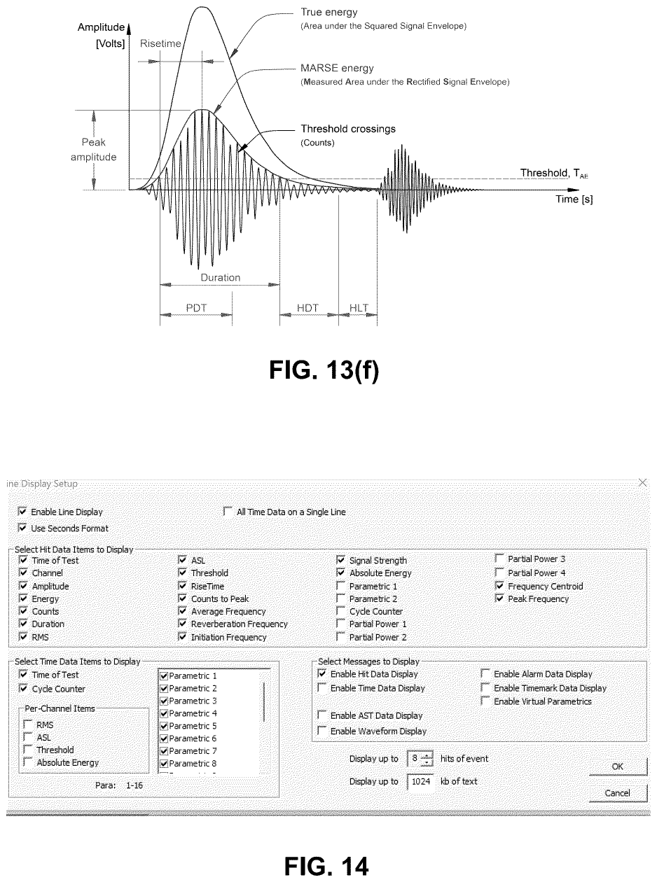

Instruments commonly used in AE monitoring include preamplifiers, sensors, and data acquisition, analysis, and storage. The overall goal of the monitoring process is to record the AE waveform and identify various AE features. A schematic of commonly used AE features, such as “amplitude,” “counts,” “energy,” “rise time,” and “duration,” is shown in FIG. 13(a), which otherwise graphically and schematically illustrates an exemplary acoustic emission sensing arrangement.

FIG. 13(b) graphically illustrates a representative waveform recorded during an impact experiment.

AE signals (such as seen in FIG. 13(b)) were processed to extract relevant features. The purpose was to distill the complex information embedded within the signal into a set of specific representative values that effectively capture the properties of the AE signal. In the presently disclosed subject matter, a total of 15 key features including amplitude, average signal level, root mean square, energy, signal strength, absolute energy, rise time, duration, counts, counts to peak, average frequency, centroid, reverberation frequency, and initial frequency were derived from the signal (descriptions of terminology are available in the Mistras User's manual). These 15 features were selected as they have shown positive performance for source localization. Such list of features, along with their descriptions, is provided in FIG. 13(c) (Table 3).

A feature-based approach (versus waveform based) was utilized in this presently disclosed subject matter because it is 90% less computationally expensive, taking less than two seconds for analysis versus three to four hours. While waveform based methods typically do result in higher accuracy, the saved storage and speed of feature-based processing allows for efficient processing of large datasets making it more practical for in-flight, real-time, and other time-sensitive applications.

AE Sensor Configuration: AE sensors convert elastic waves into electrical signals. The most commonly used AE sensors are piezoelectric sensors, which work on the basis of the piezoelectric effect-certain materials generate an electrical charge when subjected to mechanical stress [5]. AE sensors are highly sensitive and can capture high-frequency signals, usually in the range of tens to hundreds of kHz, making them ideal for detecting minor damage events.

The structure of an AE sensor typically includes a piezoelectric element (e.g., PZT ceramic) that is housed in a protective case to protect it from environmental factors such as moisture, temperature changes and mechanical shocks [6]. The protective case often includes a coupling surface to ensure that elastic waves are efficiently transmitted from the monitored structure to the sensor. The performance of an AE sensor depends on several factors, including its frequency response, sensitivity and dynamic range. For example, broadband sensors are used to capture a wide range of frequencies, while resonant sensors are used to detect specific frequencies corresponding to specific damage mechanisms.

Commonly used resonant sensors include the R3I-AST, R6I-AST, and R15I-AST. The R3I-AST operates within a frequency range of 10-40 kHz, has an operating temperature range of −35 to 75° C., weighs 147 g, and requires a power supply of 20-30 VDC @ 25 mA. The R6I-AST functions in the 40-100 KHz frequency range, supports the same temperature range (−35 to 75° C.), weighs 98 g, and also requires 20-30 VDC @ 25 mA. Similarly, the R15I-AST covers a frequency range of 50-400 kHz, maintains the same operating temperature range (−35 to 75° C.), weighs 70 g, and requires the same power supply of 20-30 VDC @ 25 mA.

Commonly used broadband sensors include the WDI-AST and PKWDI. The WDI-AST operates in a frequency range of 200-900 kHz, with an operating temperature range of −35 to 75° C. It weighs 70 g and requires a power supply of 20-30 VDC @ 25 mA. On the other hand, the PKWDI has a frequency range of 200-850 kHz, a slightly wider operating temperature range of −35 to 80° C., and weighs only 51 g. Its power requirements are lower, at 4-7 VDC @ 25 mA.

Details of the sensors above are listed in FIG. 13(d) (Table 4). For monitoring during Advanced Air Mobility (AAM) flights, sensors should be lightweight and energy efficient. Additionally, a broader operating frequency range is advantageous for capturing signals across multiple bands. In this presently disclosed subject matter, each sensor mentioned above was evaluated based on specific performance criteria, with scores assigned to each metric and corresponding weights applied. The final score for each sensor was calculated as the weighted average of these scores. FIG. 13(e) (TABLE 5) provides a detailed breakdown of the scores for each criterion and the total scores for all systems.

Based on this evaluation, the PKWDI appears to be the most suitable choice for AAM flight monitoring systems in this presently disclosed subject matter. It offers a slightly broader operating frequency range compared to the other broadband sensor, while being significantly lighter and requiring less power. Such determination was based on using the following criteria and weight specifications. Similar criteria may be established for evaluation as new sensors become available, or as custom sensors are developed for the AAM market.

### Criteria:

Operating frequency: less than 100 KHz=80, higher than 100 KHz=100
Operating temperature: −35 to 75° C.=100
Power requirement: less than 20 VDC @ 25 mA=100, more than 20 VDC @ 25 mA=80
Weight: less than 60 g=100, 60-100 g=80, more than 100 g=60
Power Consumption: less than 10=100, ten to fifty=80, over fifty=60
Estimate cost: less than $500=100, more than $500=80

### Weight:

Operating frequency: 10%
Operating temperature: 10%
Power requirement: 30%
Weight: 30%
Estimated cost: 20%

Acoustic Emission Setting: Prior to AE acquisition, key parameters should be set reasonably to ensure the accuracy and reliability of the data. These parameters include threshold, sampling rate, and timing parameters.

The threshold in AE monitoring refers to the minimum amplitude level that the system considers as a valid acoustic emission event. Signals below this threshold are disregarded, effectively filtering out background noise or insignificant fluctuations. This ensures that meaningful acoustic events, which may indicate material deformation, cracking, or other structural changes, are captured for analysis. By carefully setting an appropriate threshold, the system can achieve a balance between sensitivity to events and immunity to noise. In this presently disclosed subject matter, the threshold is configured at 35 dB, allowing us to capture significant signals while avoiding irrelevant noise.

The sampling rate defines how often the amplitude of a signal is measured and recorded by the system, typically expressed in samples per second or Hz. A higher sampling rate captures more data points, providing a more detailed and accurate representation of the waveform. This is particularly important in AE monitoring, where high-frequency signals carry critical information about the structural behavior of materials. The sampling rate was set to one MHz, ensuring that the rapid and subtle changes in the signals are recorded.

During AE acquisition, it is rare for a single waveform to be unaffected by interference from other waves and produce the ideal AE signal [7], as shown in FIG. 13(a). More often, multiple waveforms overlap or are close together, producing a noisy signal similar to that shown in FIG. 13(f) [8]. To avoid errors and misleading data collection when capturing complex waveforms, timing parameters were introduced. The following timing parameters are illustrated in FIG. 13(f). Peak Definition Time (PDT) is the time after which the system attempts to determine a new peak amplitude. The original peak amplitude is not replaced after PDT has expired. Hit definition time (HDT) is the time after the last threshold crossing when a hit ends. Hit lockout time (HLT) is the time after HDT expires when a threshold crossing does not activate a new hit. A new hit can only start after both HDT and HLT have expired. Maximum duration is the maximum time a hit can be recorded before the start of a new hit is automatically ended [7]. These timing parameters can prevent errors in AE signal acquisition to a certain extent. In lieu of project or specimen specific settings, PDT may be set at 200 μs; HDT at 400 μs; and HLT at 400 μs.

Signal Processing and Filtering: Each impact event generates a series of signals. For each impact event, only the earliest received signal with the greatest amplitude is retained for analysis. It represents the initial arrival of the elastic wave generated. The initial wave is important for achieving accurate positioning because it corresponds directly to the impact source and is not disturbed by secondary phenomena.

Subsequent signals from the same impact are ignored. These later signals are usually caused by reflections from boundaries or irregularities in the material. Reflected signals can introduce noise and complexity in the data, making it difficult to distinguish the true source location. By excluding these reflected signals the data set is cleaned up and the analysis can focus on the primary wave only.

AEwin software (Mistras Group, Inc.) was used to extract features from the data collected. FIG. 14 shows imagery illustrating the exemplary AEwin feature extraction settings.

Impact Localization Algorithm: In this module, impact localization is treated as a classification problem. The surface of the AAM structure is divided into several regions of approximately equal area. A random forest model is employed, taking 15 features extracted from the AE signals generated by the impact as input. The classifier outputs the region where the impact occurred.

Model Selection Process: There are several classic machine learning models that have proven effective in the field of classification, such as artificial neural networks (ANN), support vector machines (SVM), and random forest (RF).

ANN is a computational model inspired by the structure and function of the human brain. It includes interconnected layers of artificial neurons that process input data through weighted connections. Each neuron computes an output using a non-linear activation function, which enables the network to model complex relationships in the data. The architecture of a network typically includes an input layer, one or more hidden layers, and an output layer. The training process involves optimizing the connection weights via backpropagation, a technique that minimizes the error between the predicted and actual results using the gradient descent method [9].

SVMs are supervised machine learning models for classification and regression tasks. They seek to separate data points belonging to different classes by finding an optimal hyperplane. The hyperplane is determined by the maximum margin, i.e., the distance between the hyperplane and the nearest data point in each class, called the support vector. SVMs can handle non-linear data by using a kernel function, which maps the input data to a higher dimensional space, thereby achieving linear separation [10].

RF is an ensemble learning method that constructs multiple decision trees during training and aggregates their predictions to produce the final output. Each tree in the forest is trained on a bootstrap subset of the data set and at each split, a random subset of features is considered. This randomness introduces diversity between the trees, which improves the robustness of the model and reduces the likelihood of overfitting [11].

The selection of RF in this presently disclosed subject matter was based on the test results. In the tests, random forests consistently achieved the highest classification accuracy compared to ANN and SVM. Its ability to handle noisy data, interpret feature importance, and provide reliable predictions with limited tuning made it the most practical and effective choice for this presently disclosed subject matter.

Introduction of RF Model: The random forest (RF) algorithm, an ensemble learning technique, constructs multiple decision trees during training by utilizing bootstrapping and random feature selection. Through this process it creates diversity among the trees, reducing the risk of overfitting while maintaining predictive accuracy [12]. By aggregating the predictions of these trees through voting or averaging, random forest strikes a balance between bias and variance, and can deliver reliable predictions with minimal tuning.

As noted above, RF is an ensemble classifier comprising multiple decision trees. These decision trees are independently trained and their results are aggregated to make the final prediction based on majority voting. Currently, the most used decision tree algorithms include C4.5 and Classification and Regression Trees (CART).

C4.5 refers to a decision tree where each node can branch into multiple child nodes. However, it does not support feature combinations and is limited to classification tasks [13]. In contrast, CART decision trees split each node into only two child nodes, support feature combinations, and can be applied to both classification and regression problems [14].

This module uses Gini impurity as the criterion for splitting nodes in the CART decision trees. The steps to create a random forest are as follows:

(1) Sample randomization: Assume there is an original dataset named T which has N samples. By using the bootstrapping method, N samples are taken from the original dataset T with replacement and form a new subset. These N samples in the new subset may contain samples that have been taken many times, or samples that have never been taken. The probability that a sample has never been taken can be obtained by Eq. (1):

$$h ( N ) = {( 1 - \frac{1}{N} )}^{N} \qquad ( 1 )$$

Eq. (2) can calculate the limit of the probability:

$${lim}_{N \to ∞} {( 1 - \frac{1}{N} )}^{N} = 0.368 \qquad ( 2 )$$

According to Eq. (2), nearly 36.8% of the data in the original data set may not appear in the new subset. This unselected data is called out-of-bag (OOB) data, which can be used to evaluate the generalization performance of the decision tree.

(2) Feature randomization: Assume each sample in the new subset has n features. t features (t≤n) are randomly selected and transferred to the decision tree. By calculating the information contained in each feature, a feature with the most classification ability is selected for node branching. Eq. (3) presents the relationship between n and t.

$$t \approx \sqrt{n} \qquad ( 3 )$$

(3) Create a decision tree: By repeating step (1) and (2) for m times, m subsets that contain t features in each sample can be obtained. Each subset is transferred to an individual decision tree. In other words, m decision trees are created.

(4) Form the random forest: the m trees are formed into a random forest. The decision trees inside the random forest generate their own classification results. The results are determined according to the number of votes.

### RF Model Configurations

In general, the accuracy of a Random Forest increases as the number of decision trees grows. However, once the number of decision trees reaches a certain threshold, the error converges to a specific value. Further increasing the number of trees does not improve accuracy but significantly raises the computational cost of the Random Forest. Therefore, determining an optimal number of decision trees is critical for efficiency.

To identify an optimal number, the random forest model is evaluated with tree counts ranging from 3 to 200. The results show that classification accuracy steadily improved as the number of trees increased, but beyond approximately 100 trees, there is no notable change in accuracy. Consequently, the number of decision trees in this model is set to 100.

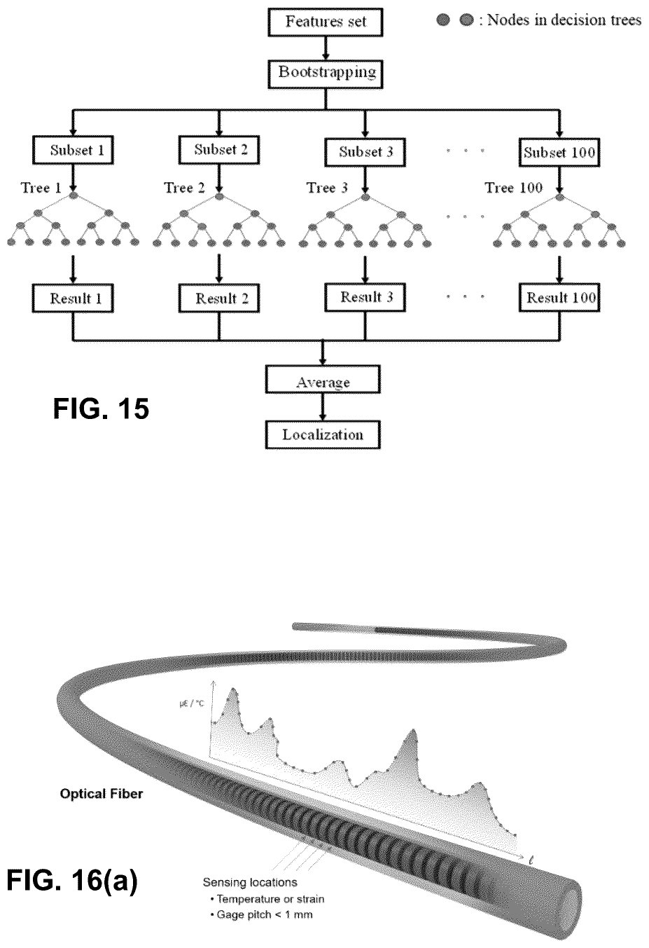

The random forest algorithm was applied to predict impact locations based on AE features. FIG. 15 graphically illustrates the structure of a random forest regression model with 100 decision trees.

### Impact Energy Estimation Module

Introduction: The impact energy estimation Module estimates the energy level of impacts on AAM structures using AE signal intensity and fiber optic strain data. This is achieved by calculating severity and historic indices, which provide insights into the intensity and cumulative nature of AE signals, reflecting impact energy and potential damage. In addition, the AE severity can be fused with fiber optic sensor data to further optimize the impact energy estimation module.

### Fiber Optic Sensors

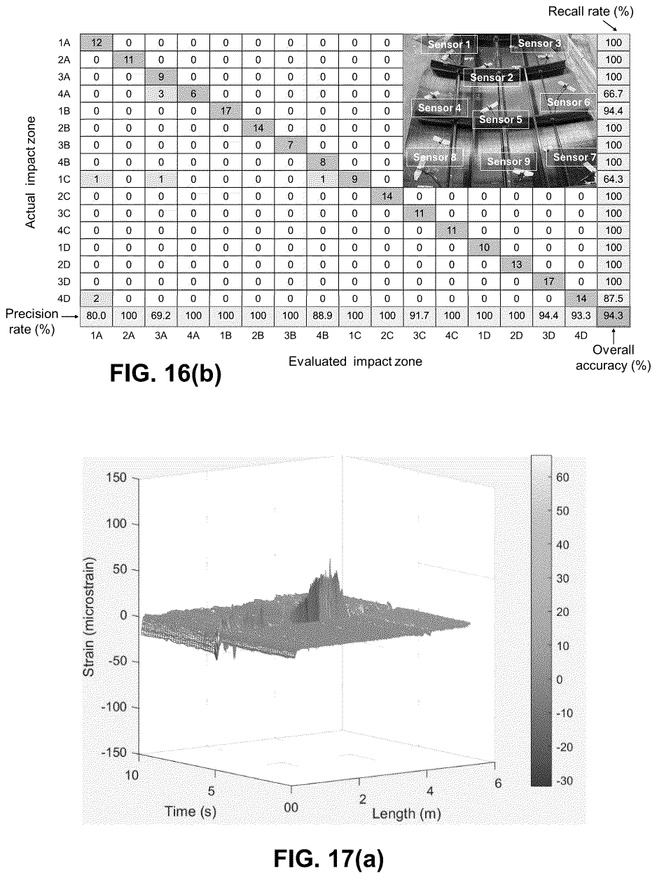

In addition to AE sensors, fiber optic sensors have proven useful for detecting impacts and associated damage and are therefore also considered for this presently disclosed subject matter. There are multiple types of fiber optic sensors including high-definition fiber optic strain sensor (HD-FOS), Fiber Bragg Gratings (FBG), and Fabry-Perot (FP) sensors. The HD-FOS (HD65 and similar), as shown in FIG. 16(a) [15] was utilized for this presently disclosed subject matter. In particular, FIG. 16(a) illustrates exemplary high-definition fiber optic sensing. The length of such sensors can reach up to 100 meters [15], allowing them to cover large areas of AAM components, and measure strain at approximately five millimeters along the sensor. With this capability they can detect the impact point as well as the effects of the impact within a certain distance surrounding the impact point.

The fundamental principle of HD-FOS lies in the interaction between light and optical fiber. When a beam of light propagates through the fiber, microscopic variations in the refractive index cause a small portion of the light to scatter backward, a phenomenon known as Rayleigh scattering. Consequently, when the fiber undergoes strain, it induces changes in the refractive index, leading to corresponding changes in the backscattered light pattern. By monitoring these changes the strain distribution along the fiber can be inferred [16].

To extract this information with high spatial resolution, Optical Frequency Domain Reflectometry (OFDR) is typically employed as the sensing technique. OFDR sends a laser signal with a precisely controlled and swept wavelength through the fiber while analyzing the backscattered light at different wavelengths. This technique enables the detection of slight variations in the backscattered signal along the fiber length, which directly corresponds to the strain changes experienced by the fiber. By performing this analysis at densely spaced intervals, a highly detailed strain map can be generated, capturing strain variations across the entire length of the fiber [16].

To reduce weight and cost of the monitoring system this presently disclosed subject matter initially considered the effect of impact localization with a single sensor. Using a confusion matrix, relationships between predicted labels vs actual labels are understood. A confusion matrix summarizes the performance of a model by tabulating the counts of true positive (TP), true negative (TN), false positive (FP), and false negative (FN) predictions. TP represents the instances correctly predicted as positive, TN represents the instances correctly predicted as negative, FP represents the instances incorrectly predicted as positive, and FN represents the instances incorrectly predicted as negative. The diagonal elements (TP and TN) indicate correct predictions while the off-diagonal elements (FP and FN) represent errors. By examining the confusion matrix, the accuracy of the model, precision, recall, and F1-score are assessed. This provides insights into the strengths and weaknesses of the model, aiding in fine-tuning and improving its performance. FIG. 16(b) graphically and with images illustrates a confusion matrix of the localization results when only sensor 5 is utilized. An accuracy of 94.3% can be achieved using only this sensor.

### Signal Processing and Filtering

A threshold (35 dB) is set to reduce AE noise interference. This threshold ensures that only signals with sufficient amplitude are captured, discarding low-intensity noise. This threshold can be modified depending on the noise environment or sensor sensitivity.

Unlike the localization module, this module requires all signals generated by impact to be included, not only the earliest received signal with the highest amplitude. However, it is still crucial to eliminate the influence of irrelevant noise. To ensure data validity it is necessary to confirm whether at least three or more AE sensors detect the same AE event. Only AE events captured by at least three sensors should be retained for analysis.

A time window of 0.0001 seconds is established to determine whether three or more signals are detected by different sensors within this time. If this condition is met, the signals are considered to be a valid signal set and included in the analysis. Otherwise, the signals are discarded. This method helps to filter non-impact-generated noise and ensure that only reliable data from actual impact events is used.

### Impact Energy Estimation Algorithms

Two algorithms are developed for impact energy estimation. The first algorithm relies solely on AE data to reduce the cost and weight of the sensing system. The second algorithm performs data fusion of AE and optical fiber data to increase the accuracy of impact energy estimation.

a) Impact Energy Estimation with AE Signals

The method for estimating energy of the impact with AE signals is based on intensity analysis [17]. This approach has demonstrated effectiveness in numerous applications, including fiber-reinforced composites. The analysis entails computing two key metrics: severity (Sᵣ) and historic index (H(t)), both metrics are derived from signal strength measurements. Severity is calculated as the mean of fifty events with the highest signal strength. This parameter is dynamic and can be continuously updated with the recording of new signals. A notable increase in severity often correlates with the initiation or detection of structural damage. On the other hand, the historic index estimates changes in the slope of recorded signal strength. It compares the strength of recent hits with the cumulative signal strength of all recorded hits. Historic index can assess and quantify spikes in cumulative signal strength, thereby providing an assessment of damage. The calculations for severity (Sᵣ) and historic index (H(t)) are provided in Eq. (4) and Eq. (5), respectively. The intensity of AE data can potentially be visualized by plotting the maximum severity-historic index obtained during each flight.

$${S}_{r} = \frac{1}{50} {\sum }_{i = 1}^{i = 50} {S}_{oi} \qquad ( 4 )$$

$$H ( t ) = \frac{N}{N - K} \frac{{\sum }_{i = K + 1}^{N} {S}_{oi}}{{\sum }_{i = 1}^{N} {S}_{oi}} \qquad ( 5 )$$

In this context, N represents the total number of hits recorded up to a specific time point (t), while Sₒᵢ denotes the signal strength of the i-th event. The factor K is determined empirically and varies depending on the number of hits. Suggested values for K have been established as follows: (1) K is not applicable when N≤50; (2) K is set to N-30 if 51≤N≤200; (3) K is calculated as 0.85 N when 201≤N≤500; and (4) K is N-75 for N≥501. These values are based on previous studies and were incorporated here even though the number of hits was small in the testing described. The full algorithm will be utilized in-flight data, resulting in more realistic values for historic index. The AE signals generated by different energy impacts have signal severity levels distributed in different numerical intervals, which can be used to approximately estimate the impact energy.

b) Impact Energy Estimation with the Data Fusion of AE and Fiber Optic Data

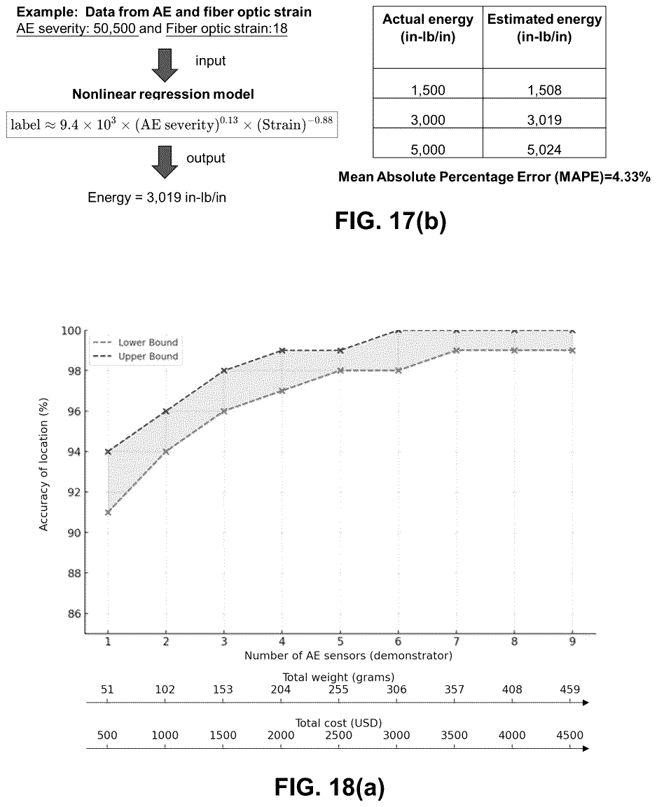

FIG. 17(a) graphically illustrates strain captured by a fiber optic sensor prior to, during, and after an impact event. The length axis represents the entire length of the fiber optic sensors. The effect of the impact event is clear in terms of both magnitude and location.

AE signals obtained after impact and high-definition strain captured by a fiber optic sensor was combined into a nonlinear regression model. When AE is used alone only the classification of impact energy was obtained. When fiber optic data is combined with AE data, the resulting regression model provides numerical estimation of the impact energy. For example, FIG. 17(b) graphically illustrates data fusion using nonlinear regression model. The input for the nonlinear regression model includes AE severity and fiber optic strain data, while the output represents the numerical value of impact energy. FIG. 17(b) provides an example where AE severity and fiber optic strain data corresponding to 13.35 J/mm (3,000 in-lb/in) are fed into the model, and the output correctly identifies the impact energy as 13.43 J/mm (3,019 in-lb/in), which is close to the actual condition. FIG. 17(b) also shows a comparison of predicted vs. actual energy for each of the three levels. The mean absolute percentage error (MAPE)=4.33%, in other words, the accuracy of energy estimation is 1−MAPE=95.7%.

### c) Exploring Trade-Offs Between Number of Sensors and Accuracy of Localization

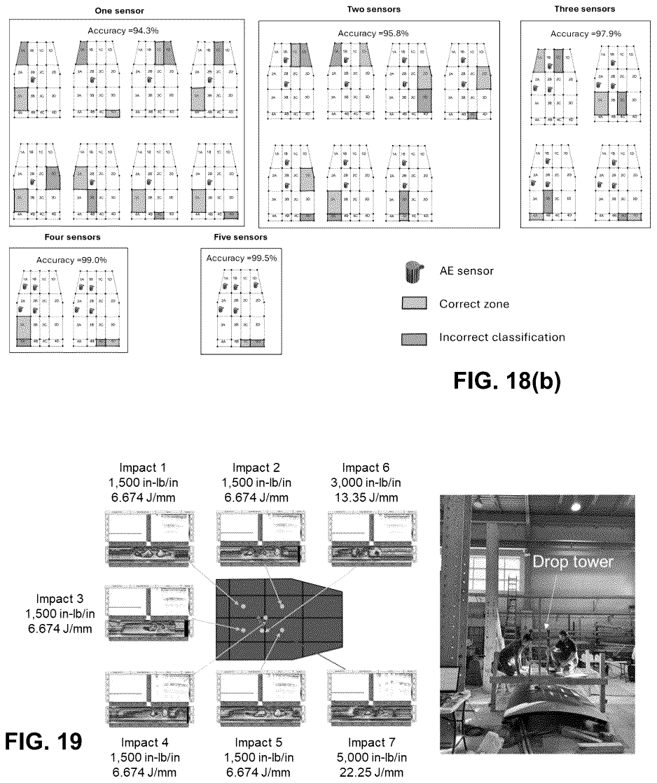

Incorporating data from additional sensors into the dataset during impact localization can significantly enhance accuracy. However, this improvement comes with increased cost and weight. FIG. 18(a) graphically illustrates the impact or tradeoff of increasing the number of sensors on localization accuracy, cost, and weight.

It is evident that as the number of sensors increases localization accuracy also improves, as do cost and weight. Trade-offs between localization accuracy, cost and weight must be managed based on the requirements and desires of specific AAM vehicle manufacturers with consideration to factors including energy of the impact event and potential consequence for a specific location.

FIG. 18(b) graphically depicts errors in localization when using two to five sensors. Green shaded areas (for example, zone 3A in one sensor illustrations) represent correct localizations and areas in red (for example, zone 1A in one sensor illustrations) represent incorrect localizations. When the number of sensors reaches six or more localization accuracy approaches 100%.

Two methods for processing AE signals were considered to better understand accuracy and computational efficiency. The first method combines AE features with a random forest algorithm. The second method utilized AE waveforms combined with a convolutional neural network.

The computation time needed when using the first method was 1.45 seconds while the time needed for the second method required 1,835 seconds. The first method resulted in accuracy between 92% and 94% while the second method resulted in accuracy between 95% and 97%. The first method saves approximately 99.9% of computation time and 99.1% of storage space, accompanied by a 3% reduction in accuracy. For in-flight sensing efficiency in computational performance is crucial. The first method (combining AE features with a random forest algorithm) was therefore selected for implementation.

In addition to impacting the demonstrator with the steel spheres described, the demonstrator was also impacted through a tower setup similar to that used for the compression after impact testing. FIG. 19 graphically and with imagery illustrates exemplary impact testing on the demonstrator using a drop tower. The green circles (for example, regarding Impact 1) represent impacts with energies of 6.674 J/mm (1,500 in-lb/in); orange circles (for example, regarding Impact 6) represent impacts with energies of 13.35 J/mm (3,000 in-lb/in); and red circles (for example, regarding Impact 7) represent impacts with energies of 22.25 J/mm (5,000 in-lb/in). FIG. 19 also shows results from a hand-held ultrasonic roller after each impact. These impact energy levels were determined based on the observations in the CAI and FE results, as they show that impacts with an energy of around 6.522 J/mm led to significant reductions in compressive strength with barely visible damage.

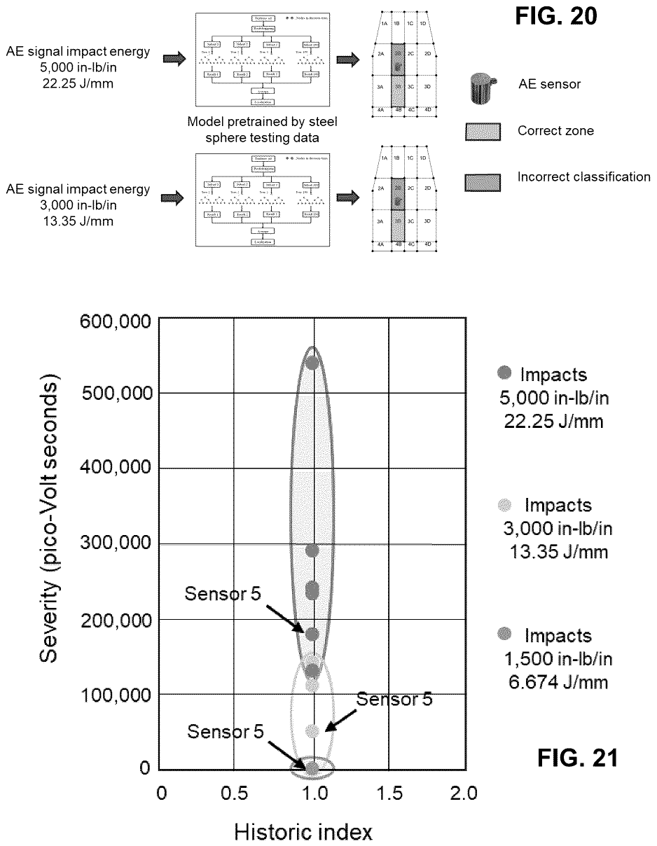

The aforementioned localization model, trained using impact signals from steel spheres, was applied to localize acoustic emission signals generated by the impact tower. FIG. 20 graphically and with imagery illustrates localization models based on exemplary signals generated with the drop tower set-up. For impact energies of 13.35 J/mm (3,000 in-lb/in) and 22.25 J/mm (5,000 in-lb/in) some errors in localization were present, resulting in misplacement of impact localizations to a different zone. It should be noted that the impact energies from the impact tower are significantly higher than those from the steel sphere impacts. Although some errors in localization occurred they fell within an acceptable range for the approach to demonstrate practical value.

Intensity analysis was performed on the AE signals generated through different energy impacts obtained from the experiment per FIG. 19 and results are shown in FIG. 21. In other words, FIG. 21 graphically illustrates estimation of impact energy (severity vs. Historic index). The points in FIG. 21 represent severity based on AE signals received by sensors under different impact energies. The red points correspond to an impact energy of 22.25 J/mm (5,000 in-lb/in), and indicate that eight sensors detected signals with severity values ranging from 120,000 to 550,000 pico-Volt seconds (some points overlap). The severity detected by sensor five, used for impact localization, is 163,000 pico-Volt seconds. The yellow points correspond to an impact energy of 13.35 J/mm (3,000 in-lb/in), indicating that nine sensors detected signals, with severity values ranging from 0 to 130,000 pico-Volt seconds, and sensor five recorded severity of 50,500 pico-Volt seconds. The green points, corresponding to an impact energy of 6.674 J/mm (1,500 in-lb/in) also indicate nine sensors detecting signals; however, all green points overlap, indicating that the severity value for all sensors, including sensor five is pico-Volt seconds. The Historic index is the same for all three energies as the number of hits is less than 50, therefore the energy of the impacts can be estimated through severity alone. The severity of the signals due to different impacts is distributed in different value intervals, allowing for an approximation of the impact energy.

One limitation of this method is that only three energy levels can be classified at present due to the limited impact test data available. Future considerations may include more samples, more energy levels, and a wider variety of impact tests. Another limitation is that performance of the method may vary depending on the material and geometry of the sample. Therefore, to apply the method to AAM structures in the future, the experimental procedures would be repeated for structural components and systems of interest.

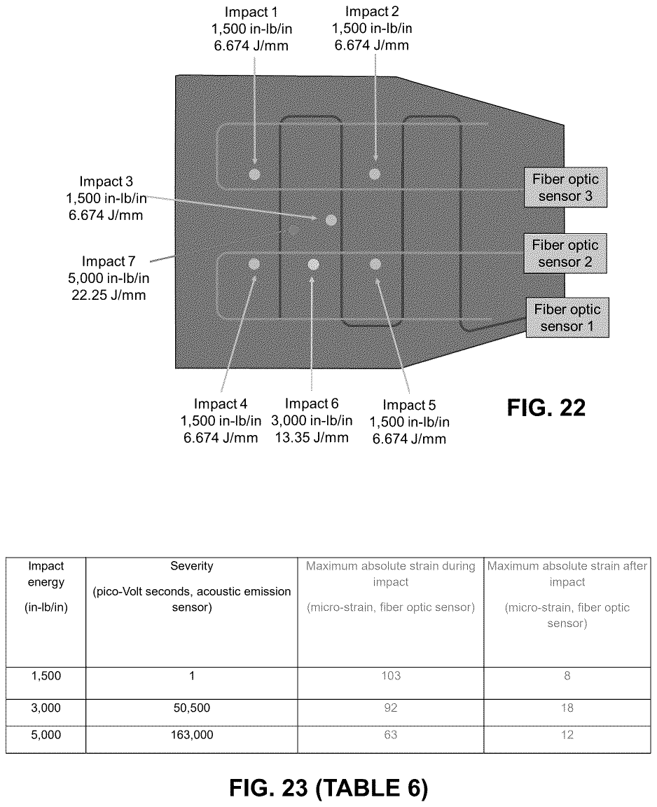

To improve estimation of impact energy, strain data gathered from high-definition fiber optic sensors (Luna Innovations) was combined with the AE data. Three high-definition fiber optic sensors were affixed to the demonstrator in an overlapping pattern and interrogated (ODiSI interrogator, Luna Innovations). FIG. 22 graphically illustrates the use of such multiple fiber optic sensors on the exemplary demonstrator.

Strain captured by a fiber optic sensor prior to, during, and after an impact event is shown in FIG. 17(a). The length axis represents the entire length of the fiber optic sensors. The effect of the impact event is clear in terms of both magnitude and location.

AE signals obtained after impact and high-definition strain captured by a fiber optic sensor was combined into a nonlinear regression model. When AE is used alone, only the classification of impact energy was obtained. When fiber optic data is combined with AE data, the resulting regression model provides numerical estimation of the impact energy. The fiber optic data utilized was gathered from fiber optic sensor 2 as most of the impact events occurred in the vicinity of that sensor. FIG. 23 (Table 6) summarizes the AE data (in terms of severity) and maximum strain recorded by the fiber optic sensor for the different impact energy levels considered.

AE signals obtained after impact and high-definition strain captured by a fiber optic sensor was combined into a nonlinear regression model. When AE is used alone, only the classification of impact energy was obtained. When fiber optic data is combined with AE data, the resulting regression model provides numerical estimation of the impact energy. The fiber optic data utilized was gathered from fiber optic sensor 2 as most of the impact events occurred in the vicinity of that sensor. FIG. 23 (Table 6) illustrates in table form the AE data (in terms of severity) and maximum strain recorded by the fiber optic sensor for the different impact energy levels considered.

As otherwise noted herein, this method is limited to estimation of impact energy in the vicinity of the three energy levels considered. Other considerations may expand the scope by including more samples, energy levels, and impact scenarios. The performance of the method may vary with material type and geometry. For application to actual AAM components and structures similar experimental procedures and energy classification methods are recommended.

### Lightweight In-Flight Data Acquisition and Processing System

The following to a degree considers advanced air mobility (AAM) market subject matter in the context of the presently disclosed subject matter, including focus on focused on the development of lightweight in-flight structural sensing systems for the AAM market. Owing to the broad range of vehicles and potential flight paths considered in this market the consideration of safety and reliability of concept vehicles is challenging. While studies have been conducted in relation to propulsion and related systems fewer investigations have considered items related to manufacturing methods, materials, and structures [20]. While a high-level vision for in-flight assessment exists it is not expected that such a vision will become reality in the near future or in the highly competitive and rapidly evolving advanced air mobility market.

Two notional vehicles were selected for this presently disclosed subject matter—the quadrotor and the lift+cruise [https://sacd.larc.nasa.gov/uam-refs/]—to help focus tools and methods development. Most studies are focused on systems that are not related, or indirectly related, to structural systems. Information on manufacturing methods, structural shapes and geometries, material types and layups, joining technologies, and structural design margins is sparse. In the current realm of aviation ground inspections play a significant role in assuring structural integrity [22]. This is undesirable, and perhaps financially infeasible, for many advanced air mobility operations. The nature of the AAM market requires a re-thinking of inspection and maintenance procedures, providing a potential point of entry for in-flight evaluation systems focused on minimizing ground inspection.

Considerations included the following:
Developing input/output schemes
Visualization of impact localization and energy estimation
Assessment of sensing system cost and weight

### Developing Input/Output Schemes

The development of input/output schemes relies on an understanding of potential safety concerns. A non-exhaustive listing of four concerns is described below, including low-velocity impact, hard landing, loss of a blade, and fatigue.

Low-velocity impact: Urban air mobility vehicles are expected to operate at relatively low altitudes for extended periods of time. Therefore the potential for low-velocity impact during flight, particularly bird impacts [23], is a consideration. Impact events may lead to delamination in composite materials that are difficult to detect through visual inspection. This is particularly true for composites manufactured with unidirectional layups (including automated fiber placement).

Hard landing: Hard landings may occur due to a number of scenarios including sudden reduction in power. Most AAM concept vehicles are designed with consideration to the loss of one or more engines and/or rotors. The quantification of a hard landing event(s) may be of interest to enable the assessment of landing gear and related structural systems that provide protection to passengers, such as fuselage components.

Loss of a blade: While most urban air mobility vehicles are designed with considerable redundancy, the loss of a blade remains a concern as the loss of one or more may damage other blades or elements of the structural system. The effect on flight characteristics due to an unbalanced rotor assembly may also be of interest.

Fatigue: Fatigue damage for metallics is relatively well understood when compared to composites. The manufacturing approaches, materials selection, and joining methodologies are more varied for composites and the environmental factors (such as temperature, moisture) and their effect on complex failure modes, and interactions of those modes, are less well understood. As a consequence, most certification approaches depend on empirical data [24]. A building-block approach is generally used, and due to the amount of empirical data required for composites this can be a costly undertaking for novel materials and joining methodologies.

The four concerns mentioned above may interact with one another. To address the concerns mentioned above, three different types of sensing systems are discussed for consideration. These types build on considerations described above for potentially minimizing the number of sensors and associated cabling while addressing one or more of the safety concerns listed above.

Acoustic emission: Acoustic emission sensing is conventionally applied to the detection and assessment of crack growth or other similar events in a wide variety of structural systems including metallics and advanced composites. Acoustic emission sensing is traditionally a passive technique, meaning that damage growth and other phenomena produce the signals. In the context of advanced air mobility, the detection and categorization of crack growth events associated with fatigue is of interest. The sizing of cracks (crack length at a given time) would likely require a predetermination of the crack growth location. Crack growth rate has been used as a substitute for geometric crack information for metallic structures and a similar approach could potentially be applied to composites. Other means of assessment include those carried over from the qualification of composite pressure vessels which generally focus on trends in acoustic emission data as functions of time and load or load history [26].

Acoustic emission sensing is presently disclosed for in-flight localization and characterization (energy level) of low-velocity impact events. In this way, AE sensors can serve two roles—namely, detection of impact events and also the more traditional role of assessing damage associated with those events. To achieve the goal of minimally intrusive sensing, machine learning algorithms based on acoustic emission signal features were developed to reduce the number of sensors and computational complexity. Acoustic emission data for in-flight impact would be gathered, such as a continuously acquired raw Acoustic Emission (AE) waveform datastream from the at least one sensor at sampling rates in the range of 500,000 to 1 million samples per second. Concerns that can be addressed by AE sensing include low-velocity impact, hard landings, and fatigue.

Fiber optic (strain, temperature): Fiber optic sensing systems are diverse with categories including fiber Bragg grating sensors and high-definition sensors. Fiber optic sensors are generally very light in weight and resistant to lightning strike. Fiber Bragg grating sensors can be multiplexed and capture temperature, displacement, vibration, and static/dynamic strain. Sensor scan rates are in the range of 5,000 samples per second. High-definition sensors can detect strain and temperature information at high resolution (~each 0.65 mm). Interrogators for this type of sensor operate at sampling rates of 60 to 250 samples per second. Discrimination between temperature and strain should be considered for fiber optics. While fiber optic sensors are light in weight and relatively inexpensive the associated interrogators are less so. Concerns that can be addressed by fiber optic sensors include low-velocity impact and hard landings.

Accelerometers: The most widely used accelerometers are piezoelectric based, however as noted above fiber optic sensors may also be used as accelerometers. Accelerometers are more sensitive to global damage given the frequencies of interest when compared to acoustic emission sensors, which are generally more sensitive to localized damage. Some overlap in frequency range does exist. Accelerometers are sometimes used to understand vibrational modes and relationships between acceleration and fatigue life [27]. In the context of the notional vehicles, the quadcopter may be more sensitive to loss of a blade, and accelerometers may be well suited to detection of such an event. The lift+cruise vehicle may be less sensitive to the loss of a blade but more sensitive to vibrational modes related to fatigue. Concerns that can be addressed by accelerometers include loss of a blade, hard landings, and fatigue.

Two sensor types (acoustic emission and fiber optic sensor) have been considered to understand and further capabilities for evaluation of low-velocity impact in the AAM market. Experimental considerations included compression after impact specimens and the demonstrator. Accelerometers were also experimentally considered in the presently disclosed subject matter. Due to the constraints on weight and cost, acoustic emission and fiber optic sensors were carried on for further consideration whereas accelerometers were not.

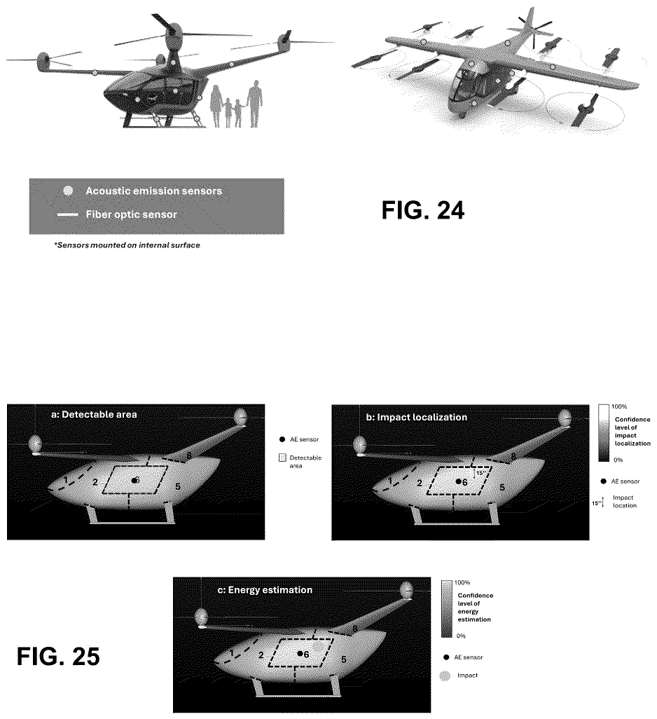

OEMs are in the best position to understand the details of specific AAM vehicles including manufacturing methods and structural detailing/joining approaches. In the absence of detailed information initial sensor types and locations are suggested as shown in FIG. 24 for the notional vehicles. In particular, FIG. 24 schematically represents suggested initial sensor types and locations for notional vehicles.

In these schematics fiber optic sensors are primarily deployed on the landing apparatus to assess hard landings and acoustic emission sensors are deployed in areas where low-velocity impact, fatigue and damage due to hard landings may be of interest. One implementation could be a semi-interactive graphical user interface (GUI). The OEM would have the capability of selecting the types of sensors, with feedback provided on inspection interval and associated cost and weight of the on-board sensing system. The approach is intended to guide the selection process and is expected to improve as details of AAM vehicles become available.

```
Inputs (from the OEM):
  Sensor type (may choose one or both)
    Fiber optic
    Acoustic emission
  Approximate sensor locations (initial locations shown above)
Outputs (to the OEM)
  Inspection interval (determined by PO 3.1)
  Weight of sensing system
  Cost of sensing system
```

Reliability is another potential output. One potential approach may be to maintain a given level of reliability and to reduce structural weight (for example, to maintain <10-9 catastrophic failures per flight hour while allowing no single failure to result in a catastrophic event). The inspection interval would also influence reliability.

### Visualization of Impact Localization and Energy Estimation

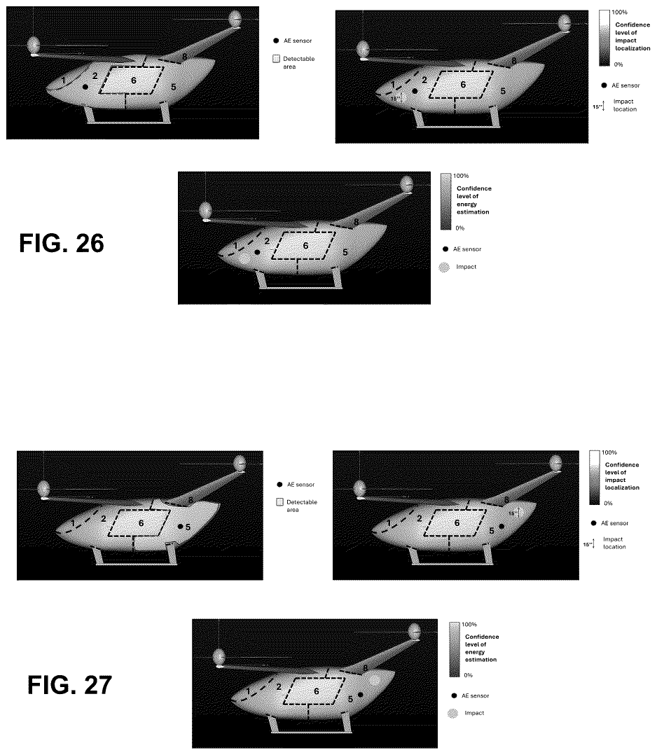

FIG. 25 schematically illustrates multiple images relating to impact localization and energy estimation for one panel (panel 6) on one side of a Quadrotor. In FIG. 25 (top left image), the green area represents the detectable region, which is the area covered by a single sensor. FIG. 25 (top right image) shows an example of a detected impact represented by a circle. The circle has a diameter of 15 inches which indicates the area within which the impact can be located and the color of the circle represents the confidence level for localization. FIG. 25 (bottom image) demonstrates the associated energy estimation with the color representing the confidence level of the energy estimation.

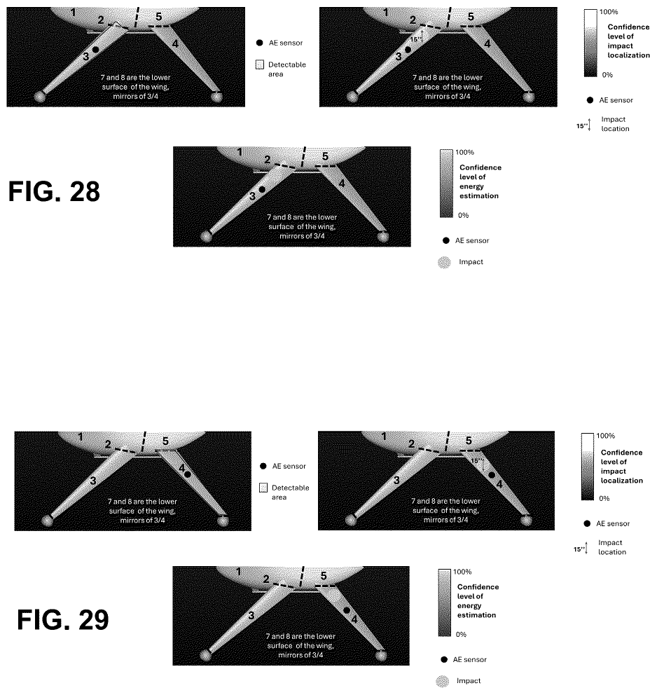

FIGS. 26-29 schematically represent multiple images which respectively represent visualization of localization and energy estimation for remaining panels of a quadrotor, including panels 1, 5, 3, and 4, respectively.

Sensor arrangement has been optimized to reduce weight and cost of the system, and this results in a tradeoff in estimation of the impact energy. Based on experience with the demonstrator it was found that AE sensors provide an estimation of impact energy. However, combining signals from AE and fiber optic strain sensors significantly improved the results for estimation of impact energy.

As the landing apparatus is of particular interest for hard landings, it is beneficial to improve the prediction of impact energy in this region. It is also possible to utilize the fiber optic strain sensors to better understand the nature of damage, if any, caused by a hard landing. This can be achieved with little additional cost in terms of weight of the in-flight sensing system in the event the fiber optic sensors can be interrogated on the ground, as opposed to during flight, as the weight of the interrogator is significant.

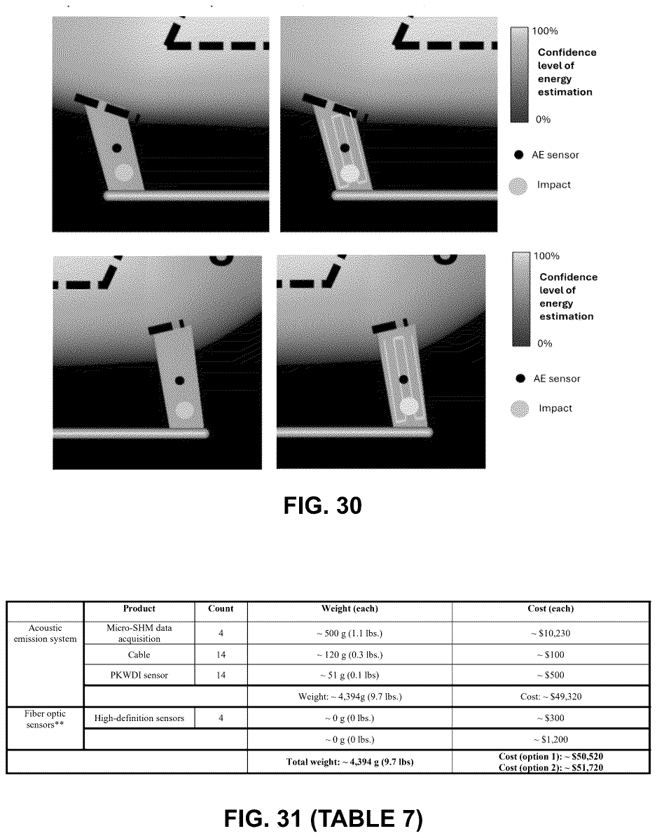

FIG. 30 schematically represents two sensing options through illustration of multiple images, in the context of landing apparatus for a quadrotor. The first option involves only the utilization of AE sensors (the two left-hand images of FIG. 30), which would be adequate for the estimation of impact localization and energy on most regions of the vehicle including the landing apparatus. The second option (the two right-hand images of FIG. 30) incorporates the use of fiber optic sensors in addition to the AE sensors to improve an understanding of a hard landing with focus on strain sensing of the landing apparatus to be assessed on the ground (post flight). The second option leverages lessons learned from impact testing completed on the demonstrator as described above. Other arrangements may involve use with a more conventional aircraft, for applying a sensor to an AAM vehicle structure such as a thermoplastic composite aircraft elevator or control surface.

### Assessment of Sensing System Cost and Weight

It is important that sensing systems presently disclosed be as light in weight and low in cost as possible while still providing benefit. For this reason, the first option includes AE sensors and in-flight data acquisition, which is the lightest weight and lowest cost option. The second option includes the same AE sensors as the first option, with high definition fiber optic sensors added to the landing apparatus. For the second option, interrogation of the fiber optic sensors would take place post flight to keep the in-flight cost and weight low. Cost and weight of these two options are presented for a quadrotor in table form in FIG. 31 (Table 7), using off-the-shelf systems. Note that the interrogator is utilized post flight only and does not affect in-flight weight or cost. Cost of the interrogator is ~$60,000 and weight is ~6,240 g (13.6 lbs).

The following recaps and summarizes some of the aspects and features of presently disclosed technology, including Impact Localization and Impact Energy Estimation Modules, including use of same.

Input and Output of the Modules: The modules use signals from acoustic emission (AE) sensors and optional fiber-optic strain sensors as input. Outputs are impact location and approximate energy of impact events.

Data Acquisition Setting: Proper parameter settings for AE data acquisition are important. Key parameters include threshold, sampling rate, and timing.

The threshold in AE monitoring effectively filters out background noise or irrelevant fluctuations. In the modules the initial threshold is set at 35 dBAE. During operation, the threshold can be adjusted as needed. If background noise is excessive, the threshold can be moderately increased. The upper bound of threshold as a general rule would be approximately 60 dBAE. Higher threshold settings result in decreased sensitivity to the impact events.

The sampling rate defines how frequently the system measures and records the signal amplitude. A higher sampling rate captures more data points, providing a more detailed and accurate waveform. The sampling rate is initially set at 1 MHz to ensure the rapid and subtle changes in the signal are recorded. This value is generally sufficient for most scenarios. Higher sampling rates may result in excessive data. Lower sampling rates may result in lower signal fidelity.

Timing settings are defined to prevent errors and misleading data collection when capturing complex waveforms.

Peak Definition Time (PDT) is the duration the system uses to determine a new peak amplitude. After PDT expires, the original peak amplitude will no longer be updated. PDT may be initially set to 200 μs. During actual applications, preliminary tests can be conducted to observe the accuracy of captured peaks. If PDT is too short, signal truncation may occur; if it is too long, it may interfere with identifying subsequent signals. Adjustments can be made based on observed results.

Hit Definition Time (HDT) is the time after the last threshold crossing when a hit is considered to have ended. HDT is typically set to twice the PDT. In this module, HDT is initially set to 400 μs. In practice, users can adjust HDT according to the actual PDT value.

Hit Lock Time (HLT) is the time after HDT ends during which threshold crossings will not activate a new hit. A new hit can only start after both HDT and HLT have expired, reducing the likelihood of capturing reflected waves. HLT may be initially set to 400 μs. During practical applications, preliminary tests can be performed to assess whether the HLT setting effectively avoids multiple hit triggers caused by reflected waves. If too many reflected wave triggers occur, HLT may be modified appropriately. Initial estimates of HLT may be estimated based on the geometry of interest and knowledge of the wave speed associated with modes of interest.

Impact Localization Algorithm: The Impact Localization Algorithm uses a random forest model. Users can make moderate adjustments based on daily feedback. If the localization result differs greatly from the actual observation, the number of decision trees in the random forest may be increased (the initial value is set to 200 trees).

Impact Energy Estimation Algorithm: The energy estimation algorithm uses AE intensity analysis and a nonlinear regression model that incorporates AE intensity analysis and high-definition optical fiber data.

AE Intensity Analysis: Intensity analysis of the AE signals is a combination of severity and historic index. The calculations for severity (Sᵣ) and historic index (H(t)) are provided in Eq. (4) and Eq. (5), respectively, as otherwise stated herein. This method has been used in many cases to better understand and quantify changes in AE signals with respect to time. In this case, severity was used to estimate impact energy. Significance of AE data can in some ways be visualized by plotting the maximum severity-historic index obtained during each flight. Indications that plot up and to the right are generally indicative of more significant events.

Nonlinear Regression Model: The nonlinear regression model uses AE severity and strain from the fiber optic sensor as inputs. The output is a numerical value of the impact energy. The nonlinear regression model is as follows:

$$Energy = C 1 \times {( AE severity )}^{C 2} \times {( Strain )}^{C 3} \qquad ( 6 )$$

C1 is initially set to 9.4×10³, C2 is initially set to 0.13, C3 is initially set to −0.88, as shown below:

$$Energy = 9.4 \times {10}^{3} \times {( AE severity )}^{0.13} \times {( Strain )}^{- 0.88} \qquad ( 7 )$$

The user can perform preliminary verification by inputting the collected fiber optic data and AE severity into the model and comparing the estimated energy with the actual energy. The nonlinear model may be re-fit based on the fiber optic data and AE severity as well as the actual energy to confirm the new C1, C2, and C3 values.

The general approach to the assessment of impact localization and evaluation of severity utilizes a procedure as described in the final report. As new sensor designs become available the general approaches described can remain largely unchanged. A similar statement is true for differing materials and geometries as the AAM market continues to evolve.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] ASTM E1316-22a, 2023. Standard terminology for nondestructive examinations. ASTM International.
[2] Gholizadeh, S., Leman, Z. and Baharudin, B. T. H. T., 2015. A review of the application of acoustic emission technique in engineering. Struct. Eng. Mech, 54 (6), pp. 1075-1095.
[3] Hamstad, M. A., 1986. A review: acoustic emission, a tool for composite-materials studies. Experimental mechanics, 26, pp. 7-13.
[4] Scruby, C. B., 1987. An introduction to acoustic emission. Journal of Physics E: Scientific Instruments, 20 (8), p. 946.
[5] Ozevin, D., 2020. MEMS acoustic emission sensors. Applied Sciences, 10 (24), p. 8966.
[6] Miller, R. K. and McIntire, P., 1987. Nondestructive testing handbook. vol. 5: Acoustic emission testing. American Society for Nondestructive Testing, 1987, p. 603.
[7] Tillmann, A. S., Schultz, A. E. and Campos, J. E., 2015. Protocols and criteria for acoustic emission monitoring of fracture-critical steel bridges
[8] Unnbórsson, R., 2013. Hit detection and determination in AE bursts. Acoustic emission-research and applications, pp. 1-20
[9] Zupan, J., 1994. Introduction to artificial neural network (ANN) methods: what they are and how to use them. Acta Chimica Slovenica, 41 (3), p. 327.
[10] Jakkula, V., 2006. Tutorial on support vector machine (svm). School of EECS, Washington State University, 37 (2.5), p. 3.
[11] Breiman, L., 2001. Random forests. Machine learning, 45, pp. 5-32.
[12] Rigatti, S. J., 2017. “Random forest”, Journal of Insurance Medicine, 47 (1), pp. 31-39.
[13] Quinlan, J. R., 2014. C4. 5: programs for machine learning. Elsevier.
[14] Breiman, L., 2017. Classification and regression trees. Routledge.
[15] LUNA, See What You've Been Missing with HD Fiber Optic Sensing, https://lunainc.com/see-what-youve-been-missing-hd-fiber-optic-sensing, Accessed Dec. 15, 2024.
[16] Young, S., Penumadu, D., Foster, D., Maeser, H., Balijepalli, B., Reese, J., Bank, D., Dahl, J. and Blanchard, P., 2020. Smart adhesive joint with high-definition fiber-optic sensing for automotive applications. Sensors, 20 (3), p. 614.
[17] Fowler, T. J., Blessing, J. A., Conlisk, P. J. and Swanson, T. L., 1989. The MONPAC system. Journal of acoustic emission, 8 (3), pp. 1-8.
[18] Hirschberg, M., “Electric VTOL Wheel of Fortune,” Vertiflite, March/April 2017.
[19] Justin, C., Patel, S., Bouchard, E., Gladin, J., Verberne, J., Li, E., Ozcan, M., Rajaram, D., and Mavris, D., D. Arpino, M., Aldamir, T., Rizzoni, G., Turkmen, G., Mayo, M., and Bivens, C., 2021, Reliability and Safety Assessment of Urban Air Mobility Concept Vehicles, NASA/CR-20210017185.
[20] Scott, G., Wincheski, R., Stelter, C., Horne, M., Moore, J., and Siochi, E., “Enhancing In-Flight Health Monitoring of Vertical Lift Vehicles Operating in an Urban Environment,” Transformative Vertical Flight 2024, 11^{th} Annual Electric VTOL Symposium, 6^{th} Decennial VFS Aeromechanics Specialists' Conference, Feb. 6-8, 2024, Santa Clara, CA.
[21] Gregory, I., Leonard, C., and Scotti, S., 2016, “Self-Aware Vehicles: Mission Performance Adaptation to System Health Degradation,” AIAA 2016-3165. 16th AIAA Aviation Technology, Integration, and Operations Conference. June 2016, DOI: 10.2514/6.2016-3165.
[22] Anon, “Maintenance Review Boards, Maintenance Type Boards and OEM/TCH Recommended Maintenance Procedures,” 2012.
[23] Devta, A., Metz, I., Armanini, F., 2023, “Experimental Evaluation of Bird Strikes in Urban Air Mobility.” DOI 10.48550/arXIV.2308.13022
[24] Tomblin, J., and Seneviratne, W., 2011, Determining the Fatigue Life of Composite Aircraft Structures using Life and Load-Enhancement Factors, Final Report, DOT/FAA/AR-10/6
[25] Yu, J., and Ziehl, P., (2012), “Stable and Unstable Fatigue Prediction for A572 Structural Steel using Acoustic Emission”, Journal of Constructional Steel Research, Vol. 77.
[26] ASME BPVC.X, 2023, “Section X-Fiber-Reinforced Plastic Pressure Vessels”, ASME, ISBN: 9780791875865, 324 pp.
[27] Van der Ven, H., Bakker, R. J. J., van Tongeren, J. H., Bos, M. J., Munninghoff, N., “A Modelling Framework for the Calculation of Structural Loads for Fatigue Life Prediction of Helicopter Airframe Components”, Aerospace Science and Technology, Volume 23, Issue 1, December 2012, Pages 26-33.
[28] The Boeing Company, 2021, NASA Revolutionary Vertical Lift (RVLT) Program, Contract #NNA15AB12B—Task #80ARC020F0054, Reliability and Safety Assessment of Urban Air Mobility Concept Vehicles

What is claimed is:

1. A computer-implemented method for assessing impact localization in an Advanced Air Mobility (AAM) vehicle structure during flight operations, the method comprising:
coupling at least one sensor directly to an associated AAM vehicle structure to be monitored;
continuously acquiring a raw Acoustic Emission (AE) waveform datastream from the at least one sensor;
processing the raw AE waveform datastream to isolate a primary incident elastic wave packet corresponding to a structural impact event by
applying a minimum amplitude threshold to filter background noise; and
implementing a temporal signal constraint logic defined by a Peak Definition Time (PDT) and a Hit Lockout Time (HLT) to retain only the earliest-arriving signal having the greatest amplitude, to isolate the primary incident elastic wave packet from subsequent reflected waves;
generating from the isolated primary incident elastic wave packet a multi-dimensional feature vector comprising at least one distinct Acoustic Emission (AE) feature including at least one of amplitude, energy, rise time, duration, counts, and signal strength;
inputting the multi-dimensional feature vector into a Random Forest Classifier model trained to predict from the multi-dimensional feature vector input a classification output corresponding to a defined spatial region of impact localization on the AAM structure; and
generating an alert signal indicating the predicted spatial region of impact localization for the AAM structure.

2. The computer-implemented method according to claim 1, wherein generating the multi-dimensional feature vector and inputting the feature vector into the trained Random Forest Classifier model are executed in real time, for continuous in-flight monitoring of the AAM vehicle structure.

3. The computer-implemented method according to claim 1, wherein:
the at least one sensor comprises at least one broadband piezoelectric sensor; and
the method further includes using an AE sensing system coupled to the at least one sensor and onboard the associated AAM vehicle structure.

4. The computer-implemented method according to claim 3, further including:
using one to six sensors; and
the raw AE waveform datastream is acquired at a sampling rate in a range of from 500 KHz to 1 MHz.

5. The computer-implemented method according to claim 1, wherein the minimum amplitude threshold is at least 35 dB to filter background noise.

6. The computer-implemented method according to claim 1, wherein the trained Random Forest Classifier model comprises a Random Forest regression model with a plurality of decision trees in a range from 3 to 200.

7. The computer-implemented method according to claim 1, wherein:
the at least one distinct Acoustic Emission (AE) feature includes signal strength; and
the method further comprises determining an impact energy level by calculating at least one of a Severity (Sᵣ) Index or a Historic Index (H(t)) from the signal strength AE feature.

8. The computer-implemented method according to claim 7, further comprising:
obtaining high-definition fiber optic strain data associated with the AAM vehicle structure; and
estimating a numerical value of impact energy by inputting a value of Sᵣ or H(t) fused with the high-definition fiber optic strain data into a nonlinear regression model.

9. The computer-implemented method according to claim 1, wherein the associated AAM vehicle structure comprises a thermoplastic composite aircraft elevator or control surface.

10. A system for assessing impact localization in an Advanced Air Mobility (AAM) vehicle structure during flight operations, the system comprising:
at least one sensor directly coupled to an associated AAM vehicle structure to be monitored, and continuously outputting a raw Acoustic Emission (AE) waveform datastream;
a Random Forest Classifier model training to predict from a multi-dimensional feature vector input a classification output corresponding to a defined spatial region of impact localization on the AAM structure;
one or more processors; and
one or more non-transitory computer-readable media that store instructions that, when executed by the one or more processors, cause the one or more processors to perform operations, the operations comprising:
processing the raw AE waveform datastream to isolate a primary incident elastic wave packet corresponding to a structural impact event by
applying a minimum amplitude threshold to filter background noise; and
implementing a temporal signal constraint logic defined by a Peak Definition Time (PDT) and a Hit Lockout Time (HLT) to retain only the earliest-arriving signal having the greatest amplitude, to isolate the primary incident elastic wave packet from subsequent reflected waves;
generating from the isolated primary incident elastic wave packet a multi-dimensional feature vector comprising at least one distinct Acoustic Emission (AE) feature including at least one of amplitude, energy, rise time, duration, counts, and signal strength; and
inputting the multi-dimensional feature vector into the Random Forest Classifier model as training data or data to process.

11. The system according to claim 10, wherein the operations further comprise:
inputting the multi-dimensional feature vector into the Random Forest Classifier model trained to predict from the multi-dimensional feature vector input a classification output corresponding to a defined spatial region of impact localization on the AAM structure; and
generating an alert signal indicating the predicted spatial region of impact localization for the AAM structure.

12. The system according to claim 10, wherein generating the multi-dimensional feature vector and inputting the feature vector into the trained Random Forest Classifier model are executed in real time, for continuous in-flight monitoring of the AAM vehicle structure.

13. The system according to claim 10, wherein the at least one sensor comprises at least one broadband piezoelectric sensor.

14. The system according to claim 13, further including one to six sensors, continuously outputting respective raw Acoustic Emission (AE) waveform datastreams at a sampling rate in a range of from 500 KHz to 1 MHz.

15. The system according to claim 10, wherein the minimum amplitude threshold is at least 35 dB to filter background noise.

16. The system according to claim 10, wherein the trained Random Forest Classifier model comprises a Random Forest regression model with a plurality of decision trees in a range from 3 to 200.

17. The system according to claim 10, wherein:
the at least one distinct Acoustic Emission (AE) feature includes signal strength; and
the operations further comprise determining an impact energy level by calculating at least one of a Severity (Sᵣ) Index or a Historic Index (H(t)) from the signal strength AE feature.

18. The system according to claim 17, further comprising:
obtaining high-definition fiber optic strain data associated with the AAM vehicle structure; and
estimating a numerical value of impact energy by inputting a value of Sᵣ or H(t) fused with the high-definition fiber optic strain data into a nonlinear regression model.

19. The system according to claim 10, wherein the associated AAM vehicle structure comprises a thermoplastic composite aircraft elevator or control surface.

20. A system for assessing impact localization in an Advanced Air Mobility (AAM) vehicle structure during flight operations, the system comprising:
at least one sensor directly coupled to an associated AAM vehicle structure to be monitored, and continuously outputting a raw Acoustic Emission (AE) waveform datastream;
a Random Forest Classifier model training to predict from a multi-dimensional feature vector input a classification output corresponding to a defined spatial region of impact localization on the AAM structure;
one or more processors; and
one or more non-transitory computer-readable media that store instructions that, when executed by the one or more processors, cause the one or more processors to perform operations, the operations comprising:
processing the raw AE waveform datastream to isolate a primary incident elastic wave packet corresponding to a structural impact event by
applying a minimum amplitude threshold to filter background noise; and
implementing a temporal signal constraint logic defined by a Peak Definition Time (PDT) and a Hit Lockout Time (HLT) to retain only the earliest-arriving signal having the greatest amplitude, to isolate the primary incident elastic wave packet from subsequent reflected waves;
generating from the isolated primary incident elastic wave packet a multi-dimensional feature vector comprising at least one distinct Acoustic Emission (AE) feature including at least one of amplitude, energy, rise time, duration, counts, and signal strength;
inputting the multi-dimensional feature vector into the Random Forest Classifier model trained to predict from the multi-dimensional feature vector input a classification output corresponding to a defined spatial region of impact localization on the AAM structure; and
generating an alert signal indicating the predicted spatial region of impact localization for the AAM structure.
